(19) United States
(12) Patent Application Publication
(10) Pub. No.: US 2017/0070313 A1
(43) Pub. Date: Mar. 9, 2017

(54) OPTICAL ADD/DROP MULTIPLEXER AND METHOD FOR ADDING/DROPPING OPTICAL SIGNAL

(71) Applicant: FUJITSU LIMITED, Kawasaki-shi (JP)

(72) Inventors: Tomoyuki Kato, Yokohama (JP); Shigeki Watanabe, Kawasaki (JP)

(73) Assignee: FUJITSU LIMITED, Kawasaki-shi (JP)

(21) Appl. No.: 15/227,548

(22) Filed: Aug. 3, 2016

(30) Foreign Application Priority Data
Sep. 3, 2015 (JP) 2015-173794

(51) Int. Cl. H04J 14/02; H04J 14/06

(52) U.S. Cl. CPC H04J 14/0204; H04J 14/06; H04J 14/0205; H04J 14/021

(57) ABSTRACT

An optical add/drop multiplexer processes input light containing reference light and a polarization multiplexed optical signal in which first wavelength division multiplexed optical signal and second wavelength division multiplexed optical signal are multiplexed. Alight source generates first and second oscillation light with different optical frequencies. A drive signal generator generates a drive signal based on a dropped signal corresponding to an optical signal dropped from the first wavelength division multiplexed optical signal. An optical modulator modulates the second oscillation light in accordance with the drive signal to generate a modulated optical signal. A polarization controller controls a polarization state of the first oscillation light and the modulated optical signal. The wavelength division multiplexed light, the first oscillation light and the modulated optical signal whose polarization state are controlled by the polarization controller are input to non-linear optical medium.

### CROSS-REFERENCE TO RELATED APPLICATION

This application is based upon and claims the benefit of priority of the prior Japanese Patent Application No. 2015-173794, filed on Sep. 3, 2015, the entire contents of which are incorporated herein by reference.

### FIELD

The embodiments discussed herein are related to an optical add/drop multiplexer and a method for adding/dropping an optical signal.

### BACKGROUND

In recent years, reconfigurable optical add/drop multiplexers (ROADMs) have been put into practical use in order to implement a flexible optical network with a large capacity. A ROADM is provided in for example each node of a WDM transmission system. A ROADM can drop an optical signal of a desired wavelength channel from a received WDM optical signal so as to guide it to a client device. In addition, a ROADM can add a data signal received from a client device to a WDM optical signal.

In order to implement the above operations, a ROADM includes a wavelength selective switch. A wavelength selective switch includes for example an array waveguide grating, a micro machine, a liquid crystal element, etc.

An optical add/drop multiplexer is described in for example Japanese Laid-open Patent Publication No. 2012-119925 and Japanese Laid-open Patent Publication No. 2011-109439. Further, an optical add drop multiplexer is also described in the documents below.

Thomas Richter et al., Coherent In-line Substitution of OFDM Subcarriers Using Fiber-Frequency Conversion and Free-Running Lasers, Optical Fiber Communications Conference and Exhibition (OFC) 2014, March 2014, pages 1-3 Peter J. Winzer, An Opto-Electronic Interferometer and Its Use in Subcarrier Add/Drop Multiplexing, Journal of Lightwave technology, Vol. 31, No. 11, Jun. 1, 2013, pages 1775-1782

In order to further increase the capacity of optical networks and/or to increase the flexibility of optical networks, methods that use communication resources (wavelength or frequency in this case) more efficiently are discussed. As an example, a multicarrier modulation that multiplexes a plurality of subcarrier optical signals is discussed. As one scheme for multicarrier modulation, for example orthogonal frequency division multiplexing (OFDM) has been used practically. In the descriptions below, an optical signal in which a plurality of subcarrier optical signals are multiplexed may be referred to as a “subcarrier multiplexed optical signal”.

In order to transmit an arbitrary subcarrier optical signal included in a subcarrier multiplexed optical signal, a technology of processing a wavelength with very small granularity may be requested. However, it is difficult to implement a wavelength selective switch having a steep transmission characteristic, and thus it is not easy to use an existing wavelength selective switch for processing optical signals, such as an OFDM signal, having spectrums overlapped on each other. In other words, according to the conventional technologies, it is not easy to process separately each subcarrier optical signal included in a subcarrier multiplexed optical signal. Accordingly, it is difficult for the conventional technologies to narrow sufficiently the wavelength spacing (or the frequency spacing) in a channel/subchannel. Further, while polarization multiplexing has been put into practical use for increasing transmission capacities, it is not easy to process individual polarization components separately. Note that in the descriptions below, a subcarrier multiplexed optical signal is one aspect of a wavelength division multiplexed optical signal.

### SUMMARY

According to an aspect of the embodiments, an optical add/drop multiplexer processes wavelength division multiplexed light containing reference light and a polarization multiplexed optical signal in which a first wavelength division multiplexed optical signal transmitted in a first polarization and a second wavelength division multiplexed optical signal transmitted in a second polarization are multiplexed, where the first polarization and the second polarization are orthogonal to each other. The optical add/drop multiplexer includes: an optical splitter configured to split the wavelength division multiplexed light to generate first wavelength division multiplexed light and second wavelength division multiplexed light; a receiver configured to generate an electric signal from the second wavelength division multiplexed light by coherent detection; a polarization estimator configured to estimate a polarization state of the wavelength division multiplexed light based on the electric signal; a light source configured to generate first oscillation light and second oscillation light, an optical frequency of the second oscillation light being different from an optical frequency of the first oscillation light; a drive signal generator configured to generate a drive signal based on at least one of a dropped signal corresponding to an optical signal dropped from the first wavelength division multiplexed optical signal and an add signal corresponding to an optical signal to be added to the first wavelength division multiplexed optical signal; an optical modulator configured to modulate the second oscillation light in accordance with the drive signal to generate a modulated optical signal; a polarization controller configured to control a polarization state of the first oscillation light and the modulated optical signal based on the polarization state estimated by the polarization estimator; and a non-linear optical medium to which the first wavelength division multiplexed light, the first oscillation light whose polarization state is controlled by the polarization controller, and the modulated optical signal whose polarization state is controlled by the polarization controller are input.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optical add/drop multiplexer that processes a subcarrier optical signal;

FIG. 2 illustrates another example of an optical add/drop multiplexer that processes a subcarrier optical signal;

FIG. 3 illustrates an example of an optical add/drop multiplexer according to an embodiment;

FIG. 4 illustrates an example of a wavelength division multiplexed light input to an optical add/drop multiplexer;

FIG. 5 illustrates an example of an optical transmitter that generates a polarization multiplexed optical signal;

FIG. 6 illustrates rotation of polarization;

FIG. 7A and FIG. 7B illustrate removal/addition of an optical signal based on a non-linear effect;

FIGS. 8A-8D illustrate a non-linear effect on a polarization multiplexed optical signal;

FIGS. 9A-9D illustrate examples of allocation of continuous wave light and modulated optical signals;

FIGS. 10A-10C illustrate examples of signal processes (deletion) by an optical add/drop multiplexer;

FIGS. 11A-11C illustrate examples of signal processes (addition) by an optical add/drop multiplexer;

FIGS. 12A-12C illustrate examples of signal processes (replacement) by an optical add/drop multiplexer;

FIG. 13 and FIG. 14 illustrate an example of an optical add/drop multiplexer according to a first embodiment;

FIG. 15 illustrates an example of an optical add/drop multiplexer according to a second embodiment;

FIG. 16 illustrates an example of an optical add/drop multiplexer according to a third embodiment;

FIG. 17 illustrates an example of a drive signal generation circuit according to a fourth embodiment;

FIG. 18 illustrates an example of polarization multiplexing; and

FIG. 19 illustrates an example of polarization combining based on drive signals.

### DESCRIPTION OF EMBODIMENTS

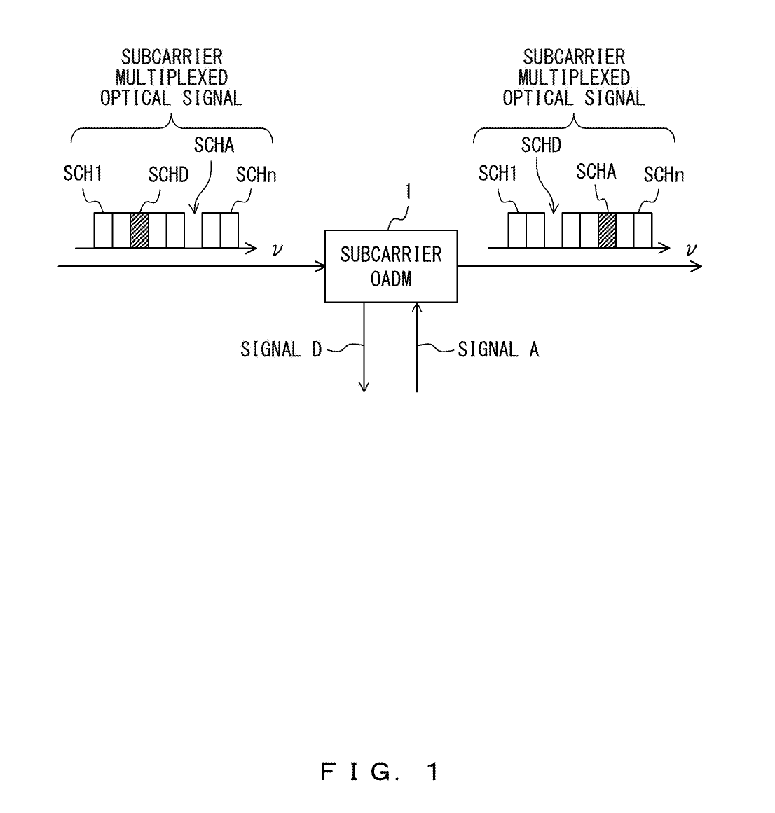

FIG. 1 illustrates an example of an optical add/drop multiplexer that processes a subcarrier optical signal. An optical add/drop multiplexer (OADM) illustrated in FIG. 1 processes a subcarrier multiplexed optical signal in which a plurality of subchannels are multiplexed. In other words, this optical add/drop multiplexer processes a subcarrier multiplexed optical signal in which a plurality of subcarrier multiplexed optical signals are multiplexed. Accordingly, this optical add/drop multiplexer may be referred to as a “subcarrier optical add/drop multiplexer (subcarrier OADM)” in the explanations below.

To a subcarrier OADM 1, a subcarrier multiplexed optical signal in which a plurality of subcarrier optical signals are multiplexed is input. The subcarrier OADM 1 can drop a specified subcarrier optical signal from a subcarrier multiplexed optical signal. In the example illustrated in FIG. 1, the subcarrier OADM 1 drops subcarrier optical signal D that is allocated to subchannel SCHD from the subcarrier multiplexed optical signal. Note that subcarrier optical signal D dropped from the subcarrier multiplexed optical signal is guided to for example a client device. Also, the subcarrier OADM 1 can add a subcarrier optical signal to a subcarrier multiplexed optical signal. In the example illustrated in FIG. 1, the subcarrier OADM 1 adds subcarrier optical signal A to a subchannel SCHA of the subcarrier multiplexed optical signal. Subcarrier optical signal A added to the subcarrier multiplexed optical signal is generated by for example a client device.

In this optical add/drop process, when a subcarrier optical signal is dropped from a specified subchannel of a subcarrier multiplexed optical signal, anew subcarrier optical signal can be added to the specified subchannel. However, when a component of the dropped subcarrier optical signal remains in the subchannel, the quality of the newly-added subcarrier optical signal deteriorates. Accordingly, when a subcarrier optical signal is dropped from a subcarrier multiplexed optical signal, it is desirable for the subcarrier OADM 1 to be able to remove the subcarrier optical signal from the subcarrier multiplexed optical signal highly accurately.

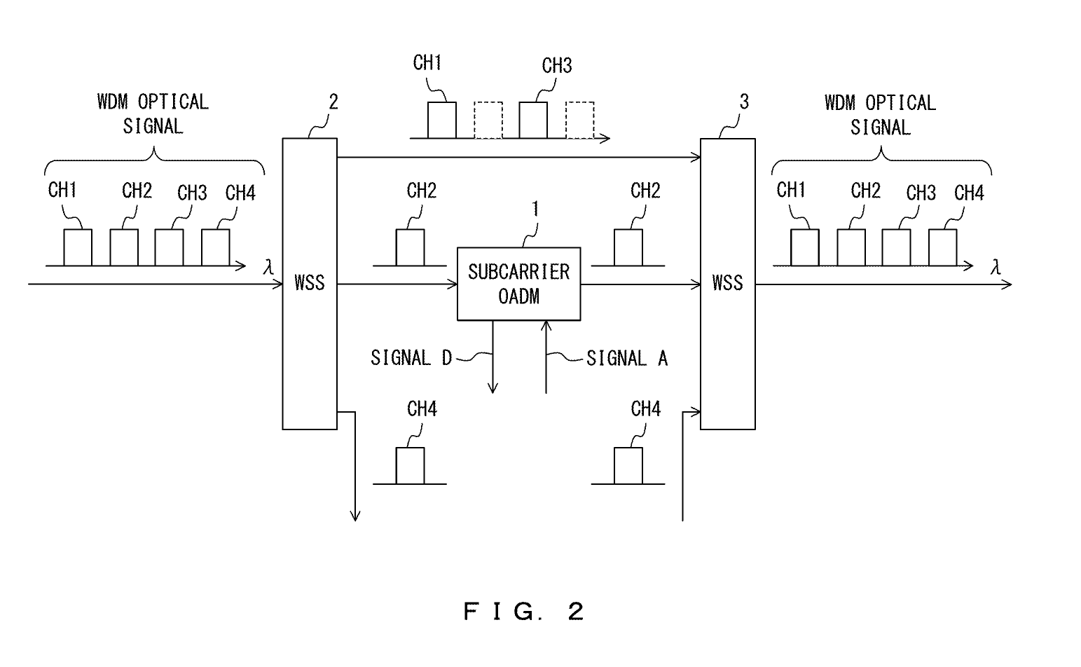

FIG. 2 illustrates another example of an optical add/drop multiplexer that processes a subcarrier optical signal. To the optical add/drop multiplexer illustrated in FIG. 2, a WDM optical signal is input. In this example, wavelength channels CH1-CH4 are multiplexed in a WDM optical signal. Each wavelength channel transmits a subcarrier multiplexed optical signal. In other words, a WDM optical signal includes a plurality of subcarrier multiplexed optical signals.

A wavelength selective switch (WSS) 2 processes a received WDM optical signal. In the example illustrated in FIG. 2, the WSS 2 guides wavelength channel CH2 to the subcarrier OADM 1, guides wavelength channels CH1 and CH3 to a WSS 3, and guides wavelength channel CH4 to a client device. The subcarrier OADM 1 processes a subcarrier multiplexed optical signal transmitted in wavelength channel CH2. The WSS 3 multiplexes wavelength channel CH2 processed by the subcarrier OADM 1, wavelength channels CH1 and CH3 guided from the WSS 2 and wavelength CH4 guided from a client device so as to generate an output WDM optical signal.

As described above, a subcarrier OADM can drop an optical signal from a desired subchannel in a subcarrier multiplexed optical signal, and can also add an optical signal to a desired subchannel in a subcarrier multiplexed optical signal. An optical add/drop multiplexer according to embodiments of the present invention can drop an optical signal from a desired subchannel in a desired polarization in a polarization multiplexed optical signal and can also add an optical signal to a desired subchannel in a desired polarization in a polarization multiplexed optical signal.

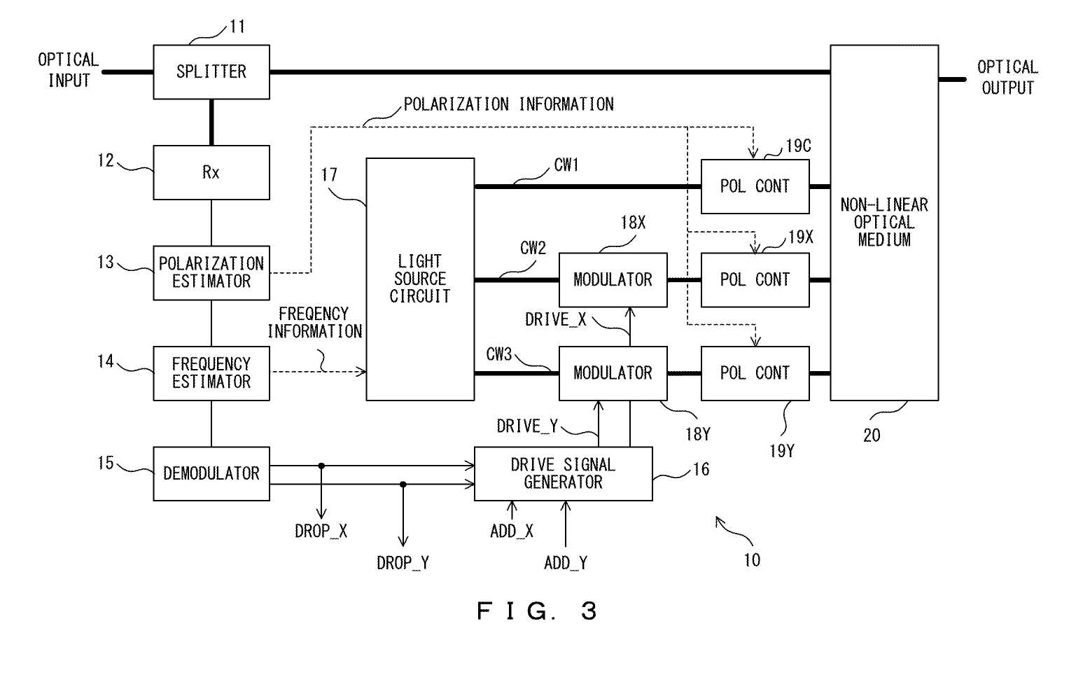

FIG. 3 illustrates an example of an optical add/drop multiplexer according to embodiments of the present invention. An optical add/drop multiplexer 10 according to the embodiment includes, as illustrated in FIG. 3, an optical splitter 11, a receiver 12, a polarization estimator 13, a frequency estimator 14, a demodulator 15, a drive signal generator 16, a light source circuit 17, optical modulators 18X and 18Y, polarization controllers 19C, 19X and 19Y and a non-linear optical medium 20.

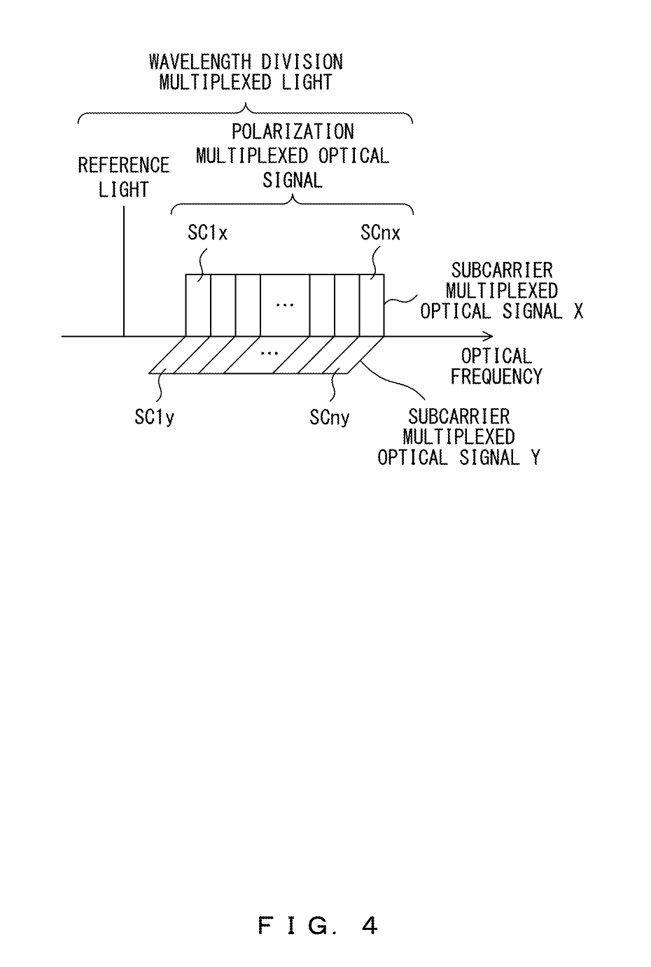

To the optical add/drop multiplexer 10, the wavelength division multiplexed light illustrated in FIG. 4 is input. The wavelength division multiplexed light input to the optical add/drop multiplexer 10 includes reference light and a polarization multiplexed optical signal. In the polarization multiplexed optical signal, subcarrier multiplexed optical signals X and Y are multiplexed. The polarizations of subcarrier multiplexed optical signals X and Y are orthogonal to each other. Also the phases of subcarrier multiplexed optical signals X and Y are synchronized with each other. A plurality of subcarrier optical signals SC1x-SCnx are multiplexed in subcarrier multiplexed optical signal X. Similarly, a plurality of subcarrier optical signals SC1y-SCny are multiplexed in subcarrier multiplexed optical signal Y.

The optical frequency of reference light is different from that of the polarization multiplexed optical signal. In this example, the optical frequency of the reference light may be lower than that of the polarization multiplexed optical signal or may be higher than that of the polarization multiplexed optical signal. Also, the difference in optical frequency between the reference light and the polarization multiplexed optical signal is not limited particularly. However, when the difference in optical frequency between the reference light and the polarization multiplexed optical signal is too small, it may be difficult to separate the reference light and the polarization multiplexed optical signal from each other. When the difference in optical frequency between the reference light and the polarization multiplexed optical signal is too large, the efficiency of the non-linear effect (such as for example four wave mixing, cross-phase modulation) deteriorates in the non-linear optical medium 20. Accordingly, it is desirable to take these factors into consideration when the difference in optical frequency between the reference light and polarization multiplexed optical signal is determined.

It is desirable that the power of the reference light be higher than that of each subcarrier optical signal as illustrated in FIG. 4. For example, it is desirable that the power of the reference light be enough high to cause a non-linear effect sufficiently in the non-linear optical medium 20. It is also desirable that a phase of the reference light is synchronized with a phase of the polarization multiplexed optical signal (i.e., subcarrier multiplexed optical signals X and Y). Note that the reference light is for example continuous wave light.

It is desirable that the polarization state of the reference light matches that of one of subcarrier multiplexed optical signals X and Y. In the example illustrated in FIG. 4, the polarization state of the reference light is substantially the same as subcarrier multiplexed optical signal X. In this case, the polarization state of the reference light is orthogonal to that of subcarrier multiplexed optical signal Y.

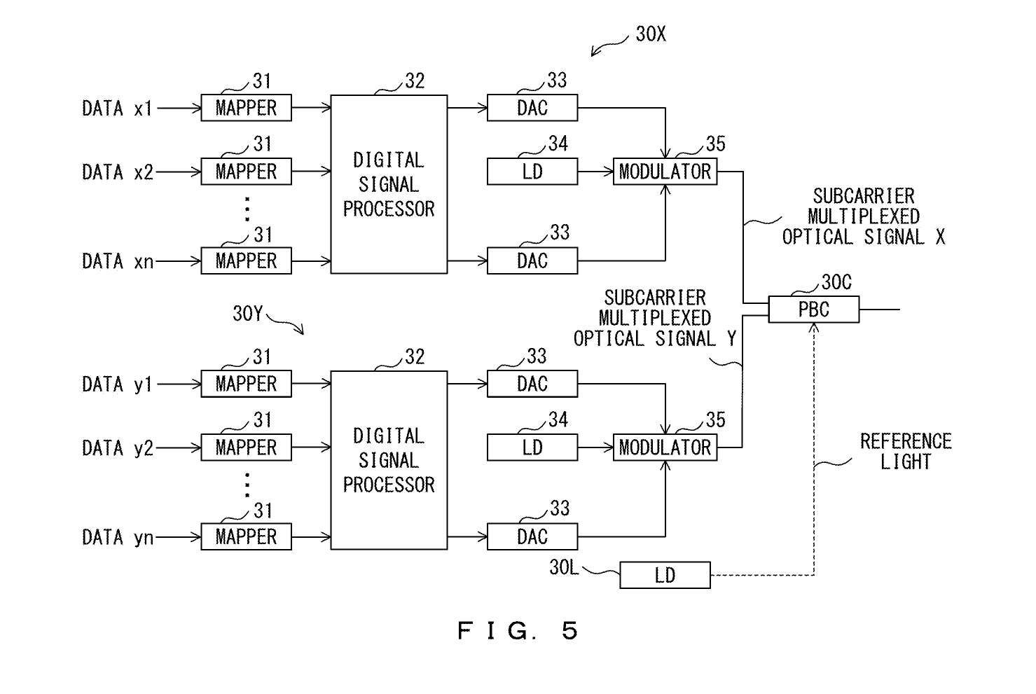

FIG. 5 illustrates an example of an optical transmitter that generates the polarization multiplexed optical signal illustrated in FIG. 4. As illustrated in FIG. 5, the optical transmitter includes a pair of optical signal generators 30X and 30Y, and a polarization beam combiner (PBC) 30C. In this example, the subcarrier multiplexed optical signals are generated by the OFDM.

The optical signal generator 30X includes a plurality of mappers 31, a digital signal processor 32, a D/A converter 33, a laser light source 34 and an optical modulator 35. The plurality of mappers 31 map data signals x1-xn to a constellation respectively in accordance with specified modulation schemes. The digital signal processor 32 processes signals output from the plurality of mappers 31. In this example, the digital signal processor 32 performs inverse FFT on signals output from the plurality of mappers 31 so as to generate a time domain signal. The D/A converter 33 performs a D/A conversion on a signal output from the digital signal processor 32 so as to generate a drive signal. The laser light source 34 generates continuous wave light of a specified optical frequency. The optical modulator 35 modulates the continuous wave light output from the laser light source 34 in accordance with the drive signal so as to generate a modulated optical signal. In other words, subcarrier multiplexed optical signal X that transmits data signals x1-xn is generated by the optical signal generator 30X. Note that data signals x1-xn are transmitted by subcarriers SC1x-SCnx.

The configuration and the operations of the optical signal generator 30Y are substantially the same as those of the optical signal generator 30X. Accordingly, subcarrier multiplexed optical signal Y that transmits data signals y1-yn is generated by the optical signal generator 30Y. Data signals y1-yn are transmitted by subcarriers SC1y-SCny. Then, the polarization beam combiner 30C multiplexes subcarrier multiplexed optical signal X generated by the optical signal generator 30X and subcarrier multiplexed optical signal Y generated by the optical signal generator 30Y so as to generate the polarization multiplexed optical signal illustrated in FIG. 4.

As illustrated in FIG. 5, the optical transmitter may include a laser light source 30L that generates reference light. In such a case, the reference light is combined with the polarization multiplexed optical signal by the polarization beam combiner 30C. In the above combining, the reference light, subcarrier multiplexed optical signal X and subcarrier multiplexed optical signal Y are combined so that the polarization state of the reference light matches that of subcarrier multiplexed optical signal X or Y. However, the reference light may be generated in a different node.

FIG. 3 is again explained. The optical splitter 11 splits a received wavelength division multiplexed light, and guides the resultant signals to the non-linear optical medium 20 and the receiver 12. Although the splitting ratio is not limited particularly, the optical splitter 11 splits the received wavelength division multiplexed light so that for example the wavelength division multiplexed light guided to the non-linear optical medium 20 has higher power than that of the wavelength division multiplexed light guided to the receiver 12.

The receiver 12 generates an electric signal representing the wavelength division multiplexed light guided from the optical splitter 11. The receiver 12 is implemented by for example a coherent detector and an A/D convertor. In such a case, the receiver 12 generates an electric signal representing the electric field information of a polarization multiplexed optical signal in the wavelength division multiplexed light. In other words, electric signals representing for example I component in the H polarization, Q component in the H polarization, I component in the V polarization and Q component in the V polarization are generated.

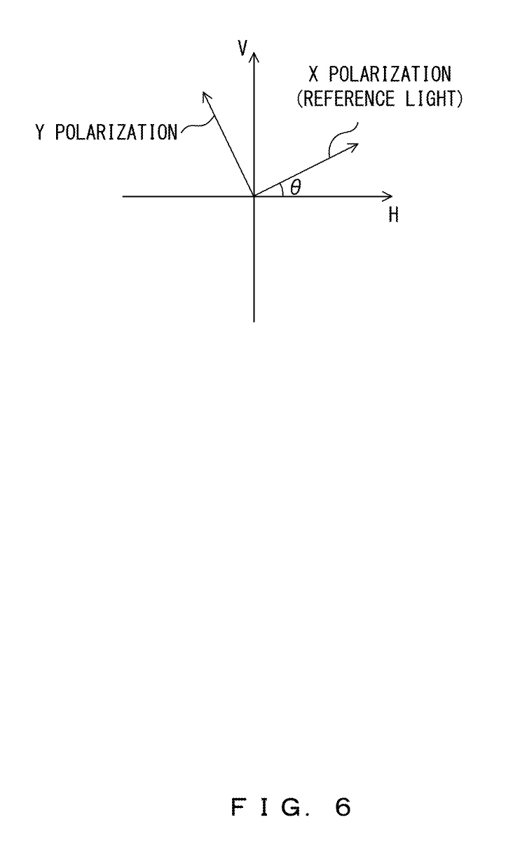

However, the polarization of a wavelength division multiplexed light (reference light and polarization multiplexed optical signal) transmitted from the optical transmitter rotates while being transmitted. In the example illustrated in FIG. 6, the polarization of the reference light has rotated by angle θ with respect to axis H. Note that axes H and V represent the reference polarization states of the coherent detection by the receiver 12.

It is assumed that the optical add/drop multiplexer 10 receives an instruction to drop subcarrier optical signal SCDx and/or SCDy from a polarization multiplexed optical signal. Subcarrier optical signal SCDx is one of a plurality of subcarrier optical signals SC1x-SCnx that are multiplexed in subcarrier multiplexed optical signal X. Also, subcarrier optical signal SCDy is one of a plurality of subcarrier optical signals SC1y-SCny that are multiplexed in subcarrier multiplexed optical signal Y.

The polarization estimator 13 estimates (or calculates) the polarization state of the wavelength division multiplexed light based on the electric signal generated by the receiver 12. Specifically, the polarization estimator 13 estimates the polarization state of the reference light and the polarization multiplexed optical signal. In the above estimation, the polarization estimator 13 may estimate the polarization state of subcarrier optical signal SCDx, which is dropped from subcarrier multiplexed optical signal X, and the polarization state of subcarrier optical signal SCDy, which is dropped from subcarrier multiplexed optical signal Y. Alternatively, the polarization estimator 13 may estimate only the polarization state of the reference light. Then, the polarization estimator 13 gives polarization information representing estimated polarization state to the polarization controllers 19C, 19X and 19Y. The polarization estimator 13 may give the polarization information to the drive signal generator 16.

The polarization estimator 13 is implemented by for example a butterfly filter including a plurality of FIR filters. In such a case, polarization information is generated based on for example the tap coefficients of each FIR filter. Also, polarization information may represent angle θ illustrated in FIG. 6. Then, the polarization estimator 13 filters a signal output from the receiver 12 by using the above filter so as to generate a signal representing an X polarization component and a signal representing a Y polarization component. In other words, electric signals that respectively represent a reference signal, subcarrier optical signal SCDx and subcarrier optical signal SCDy are generated.

The frequency estimator 14 estimates (or calculates) difference Δνx in optical frequency between the reference light and subcarrier optical signal SCDx based on an electric signal generated by the receiver 12 (or a signal output from the polarization estimator 13). Then, the frequency estimator 14 gives frequency information representing the difference Δνx to the light source circuit 17. Similarly, the frequency estimator 14 estimates difference Δνy in optical frequency between the reference light and subcarrier optical signal SCDy. Then, the frequency estimator 14 gives frequency information representing the difference Δνy to the light source circuit 17. Note that when subcarrier optical signals are dropped respectively from the X polarization and the Y polarization at an optical frequency shifted from reference light by Δν, the frequency estimator 14 may generate frequency information that represents Δν.

Based on the electric signal generated by the receiver 12, the demodulator 15 demodulates subcarrier optical signals SCDx and SCDy so as to generate dropped signals X and Y. Dropped signals X and Y respectively represent the data transmitted by using subcarrier optical signals SCDx and SCDy. Also, dropped signals X and Y are guided to the drive signal generator 16 and a client device. Then, the drive signal generator 16 generates drive signals X and Y respectively based on the inverted signals of dropped signals X and Y. In other words, drive signals X and Y are generated based on the inverted signals of dropped signals X and Y that represent the data transmitted by using subcarrier optical signal SCDx and SCDy.

The light source circuit 17 generates continuous wave light CW1-CW3 based on a specified difference. In this example, the light source circuit 17 generates continuous wave light CW1-CW3 based on the optical frequency difference specified by the frequency information. Each of the continuous wave light CW1-CW3 has an optical frequency that is different from the optical frequency of the reference light and that is also different from the optical frequency of the polarization multiplexed optical signal. Also, the difference in optical frequency between continuous wave light CW1 and continuous wave light CW2 is Δνx, which is represented by the frequency information. In other words, the difference in optical frequency between continuous wave light CW1 and continuous wave light CW2 is equal to difference Δνx in optical frequency between the reference light and subcarrier optical signal SCDx that is dropped from subcarrier multiplexed optical signal X. Similarly, the difference in optical frequency between continuous wave light CW1 and continuous wave light CW3 is Δνy, which is represented by the frequency information. In other words, the difference in optical frequency between continuous wave light CW1 and continuous wave light CW3 is equal to difference Δνy in optical frequency between the reference light and subcarrier optical signal SCDy that is dropped from subcarrier multiplexed optical signal Y. Note that it is desirable that the power of continuous wave light CW1 be higher than that of each of continuous wave light CW2 and continuous wave light CW3. For example, it is desirable that the power of continuous wave light CW1 be high enough to cause a non-linear effect sufficiently in the non-linear optical medium 20.

The light source circuit 17 may generate continuous wave light CW1-CW3 without utilizing the estimation result by the frequency estimator 14. When for example the optical frequency of the reference light is known and the optical frequencies of subcarriers that are to be dropped/added from/to a subcarrier multiplexed optical signal is specified, the light source circuit 17 may generate continuous wave light CW1-CW3 based on the difference between the optical frequency of the reference light and each of the specified optical frequencies.

The optical modulator 18X modulates continuous wave light CW2 in accordance with drive signal X generated by the drive signal generator 16 to generate modulated optical signal X. Similarly, the optical modulator 18Y modulates continuous wave light CW3 in accordance with drive signal Y generated by the drive signal generator 16 to generate modulated optical signal Y.

The polarization controllers 19C, 19X and 19Y respectively control the polarization states of continuous wave light CW1 and modulated optical signals X and Y based on the polarization information generated by the polarization estimator 13. For example, the polarization controller 19C controls the polarization state of continuous wave light CW1 so that the polarization state of continuous wave light CW1 matches the polarization state of the reference light. Also, the polarization controller 19X controls the polarization state of modulated optical signal X so that the polarization state of modulated optical signal X matches the polarization state of the reference light. Further, the polarization controller 19Y controls the polarization state of modulated optical signal Y so that the polarization state of modulated optical signal Y is orthogonal to the polarization state of the reference light.

However, whether to make the polarization states of continuous wave light CW1 and modulated optical signals X and Y match the polarization state of the reference light or to make them orthogonal to the polarization state of the reference light is selected appropriately in accordance with several conditions. These conditions will be explained later in detail.

Note that “match” and “orthogonal” are not limited to “exactly match” and “exactly orthogonal”, but include “substantially or approximately match” and “substantially or approximately orthogonal”.

To the non-linear optical medium 20, the wavelength division multiplexed light guided from the optical splitter 11, continuous wave light CW1, modulated optical signal X and modulated optical signal Y are input. Note that the polarization state of continuous wave light CW1 is controlled by the polarization controller 19C. The polarization states of modulated optical signals X and Y are controlled by the polarization controllers 19X and 19Y, respectively. The non-linear optical medium 20 is implemented by for example an optical fiber (particularly a highly non-linear fiber), a high refractive index optical waveguide using silicon, etc. as the core, a periodically polarized electro-optical crystal, etc. A plurality of optical signals having different optical frequencies enter the non-linear optical medium 20. Accordingly, a non-linear effect (such as four wave mixing, cross-phase modulation, etc.) may occur in the non-linear optical medium 20.

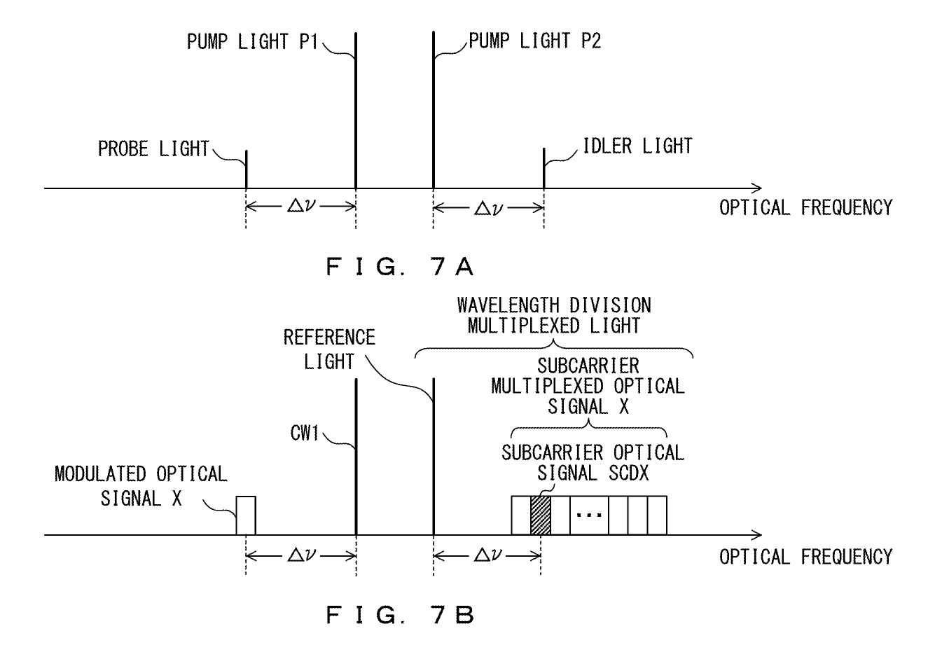

FIG. 7A and FIG. 7B illustrate removal and addition of an optical signal based on a non-linear effect. In this example, polarization is not taken into consideration in order to simplify the explanations.

FIG. 7A illustrates a state where probe light, pump light P1 and pump light P2 are input to the non-linear optical medium 20. It is assumed in this example that pump light P1 and pump light P2 each have power that is high sufficiently to cause a non-linear effect in the non-linear optical medium 20. It is also assumed that the difference in optical frequency between the probe light and pump light P1 is Δν. In such a case, idler light corresponding to the probe light is generated by the four wave mixing. The difference in optical frequency between pump light P2 and the idler light is also Δν. Also, the signal transmitted by the idler light and the signal transmitted by the probe light are identical to each other.

FIG. 7B illustrates a state where the modulated optical signal, continuous wave light CW1 and the wavelength division multiplexed light are input to the non-linear optical medium 20. In this example, Y polarization is not taken into consideration. In other words, it is assumed that modulated optical signal X generated by the optical modulator 18X, continuous wave light CW1 generated by the light source circuit 17 and the wavelength division multiplexed light split by the optical splitter 11 are input to the non-linear optical medium 20. In such a case, modulated optical signal X, continuous wave light CW1 and the reference light in wavelength division multiplexed light illustrated in FIG. 7B correspond to the probe light, pump light P1 and pump light P2 illustrated in FIG. 7A, respectively. In other words, the continuous wave light CW1 and the reference light function as pump light.

In the configuration illustrated in FIG. 3, the difference in optical frequency between the reference light and subcarrier optical signal SCDx is Δνx and the difference in optical frequency between continuous wave light CW1 and modulated optical signal X is also Δνx. In such a case, by the four wave mixing explained by referring to FIG. 7A, idler light corresponding to the modulated optical signal X is generated in the optical frequency to which subcarrier optical signal SCDx is allocated. In this example, the modulated optical signal X is generated based on the inverted signal of the dropped signal that corresponds to subcarrier optical signal SCDx. In other words, the idler light generated in the non-linear optical medium 20 represents the inverted signal of subcarrier optical signal SCDx. Accordingly, when the idler light corresponding to modulated optical signal X is generated in the non-linear optical medium 20, subcarrier optical signal SCDx is cancelled by the idler light. As a result of this, subcarrier optical signal SCDx is removed from subcarrier multiplexed optical signal X.

As described, an optical signal component of a channel dropped from a subcarrier multiplexed optical signal is removed by utilizing a non-linear effect. That is, a specified optical signal is dropped without using an optical filter etc. Accordingly, even when the spacing between optical signal channels (i.e., the spacing between subcarriers) is narrow, it is possible to accurately drop an optical signal in a specified channel.

In addition to the function of dropping a specified subcarrier optical signal from a subcarrier multiplexed optical signal, the optical add/drop multiplexer 10 has a function of adding a subcarrier optical signal to a subcarrier multiplexed optical signal. In other words, a subcarrier optical signal corresponding to a signal received from a client device (referred to as an add signal hereinafter) can be added to a subcarrier multiplexed optical signal.

In such a case, the drive signal generator 16 generates drive signal X based on the sum of the inverted signal of dropped signal X and the add signal. Then, modulated optical signal X generated in accordance with drive signal X is input to the non-linear optical medium 20.

Accordingly, the idler light that is generated when modulated optical signal X, continuous wave light CW1 and the wavelength division multiplexed light are input to the non-linear optical medium 20 corresponds to the sum of the inverted signal of dropped signal X and the add signal. In this case, as described above, subcarrier optical signal SCDx is removed by the idler light in the non-linear optical medium 20. In addition to this, the subcarrier optical signal corresponding to the add signal is inserted to the channel that was occupied by subcarrier optical signal SCDx. As a result of this, the replacement of subcarrier optical signals is achieved.

Next, explanations will be given for non-linear effect on a polarization multiplexed optical signal. It is assumed in the descriptions below that the reference light, continuous wave light CW1, modulated optical signal X and modulated optical signal Y are input to the non-linear optical medium 20.

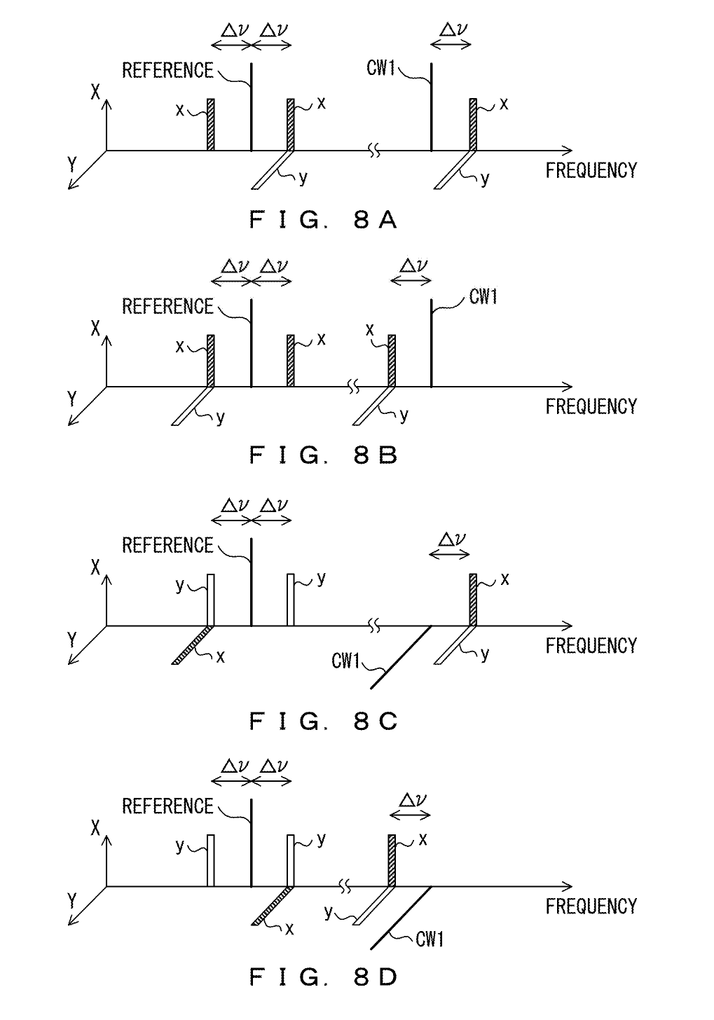

In the case illustrated in FIG. 8A, the polarization state of continuous wave light CW1 is controlled so that it matches the polarization state of the reference light. Also, the polarization state of modulated optical signal X is controlled so that it matches the polarization state of the reference light and the polarization state of modulated optical signal Y is controlled so that it is orthogonal to the polarization state of the reference light. Further, the optical frequencies of modulated optical signals X and Y (i.e., optical frequencies of continuous wave light CW2 and continuous wave light CW3) are higher than the optical frequency of continuous wave light CW1 by Δν.

In such a case, idler light beams corresponding to modulated optical signals X and Y emerge at an optical frequency higher than that of the reference light by Δν. In this situation, the polarization state of idler light x corresponding to modulated optical signal X matches that of the reference light and the polarization state of idler light y corresponding to modulated optical signal Y are orthogonal to that of the reference light. Note that idler light x corresponding to modulated optical signal X having an optical frequency lower than the reference light by Δν emerges.

In the case illustrated in FIG. 8B as well, the polarization state of continuous wave light CW1 is controlled so that it matches the polarization state of the reference light. However, the optical frequencies of modulated optical signals X and Y are lower than that of continuous wave light CW1 by Δν.

In such a case, idler light beams corresponding to modulated optical signals X and Y having optical frequencies lower than that of the reference light by Δν emerge. In this situation, the polarization state of idler light x corresponding to modulated optical signal X matches that of the reference light and the polarization state of idler light y corresponding to modulated optical signal Y is orthogonal to that of the reference light. Note that idler light x corresponding to modulated optical signal X having an optical frequency higher than reference light by Δν emerges.

As described above, when the polarization state of continuous wave light CW1 matches that of the reference light, the polarization states of idler light x and idler light y match the polarization state of modulated optical signals X and Y, respectively. Also, when the optical frequencies of modulated optical signals X and Y are higher than that of continuous wave light CW1, the optical frequencies of idler light x and idler light y are also higher than that of the reference light, while when the optical frequencies of modulated optical signals X and Y are lower than that of continuous wave light CW1, the optical frequencies of idler light x and idler light y are also lower than that of the reference light.

In the case illustrated in FIG. 8C, the polarization state of continuous wave light CW1 is controlled so that it is orthogonal to the polarization state of the reference light. Also, the polarization state of modulated optical signal X is controlled so that it matches the polarization state of the reference light while the polarization state of modulated optical signal Y is controlled so that it is orthogonal to the polarization state of the reference light. Further, the optical frequencies of modulated optical signals X and Y are higher than that of continuous wave light CW1 by Δν.

In such a case, idler light beams corresponding to modulated optical signals X and Y emerge at an optical frequency lower than that of the reference light by Δν. In this situation, the polarization state of idler light x corresponding to modulated optical signal X is orthogonal to that of the reference light and the polarization state of idler light y corresponding to modulated optical signal Y matches that of the reference light. Note that idler light y corresponding to modulated optical signal Y emerges at an optical frequency higher than that of the reference light by Δν.

In the case illustrated in FIG. 8D as well, the polarization state of continuous wave light CW1 is controlled so that it is orthogonal to the polarization state of the reference light. However, the optical frequencies of modulated optical signals X and Y are lower than that of continuous wave light CW1 by Δν.

In such a case, idler light beams corresponding to modulated optical signal X and Y emerge at an optical frequency higher than that of the reference light by Δν. In this situation, the polarization state of idler light x corresponding to modulated optical signal X is orthogonal to that of the reference light and the polarization state of idler light y corresponding to modulated optical signal Y matches that of the reference light. Note that idler light y corresponding to modulated optical signal Y emerges at an optical frequency lower than that of reference light by Δν.

As described above, when the polarization state of continuous wave light CW1 is orthogonal to that of the reference light, the polarization states of idler light x and idler light y are orthogonal to the polarization states of modulated optical signals X and Y, respectively. When the optical frequencies of modulated optical signals X and Y are higher than that of continuous wave light CW1, the optical frequencies of idler light x and idler light y are lower than that of the reference light, and when the optical frequencies of modulated optical signals X and Y are lower than that of continuous wave light CW1, the optical frequencies of idler light x and idler light y are higher than that of the reference light.

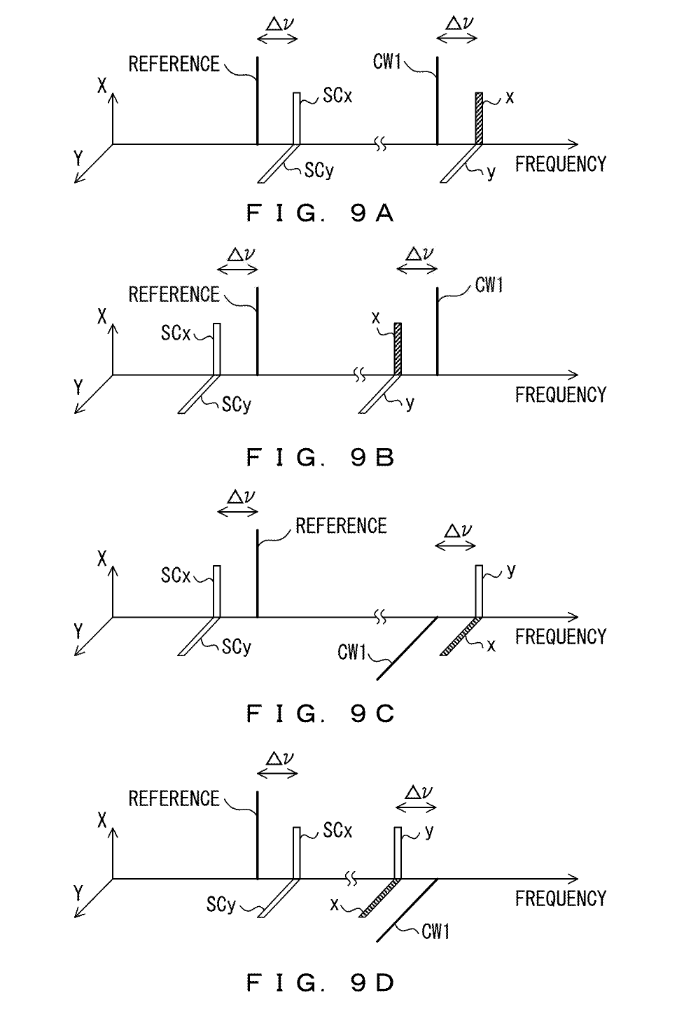

The optical add/drop multiplexer 10 controls the optical frequencies of continuous wave light CW1-CW3 and the polarization states of continuous wave light CW1 and modulated optical signals X and Y. Specifically, the optical frequencies and the polarization states are controlled as illustrated in FIGS. 9A-9D.

In the examples illustrated in FIG. 9A and FIG. 9D, subchannels SCx and SCy having an optical frequency higher than that of the reference light by Δν are controlled. Note that the polarization state of subchannel SCx matches that of the reference light and the polarization state of subchannel SCy is orthogonal to that of the reference light.

When the polarization state of continuous wave light CW1 is controlled so that it matches the polarization state of the reference light, the optical add/drop multiplexer 10 generates modulated optical signals X and Y having an optical frequency higher than that of continuous wave light CW1 by Δν as illustrated in FIG. 9A. In addition, the optical add/drop multiplexer 10 makes the polarization state of modulated optical signal X match that of the reference light and makes the polarization state of modulated optical signal Y orthogonal to that of the reference light. Then, idler light x corresponding to modulated optical signal X emerges in subchannel SCx and idler light y corresponding to modulated optical signal Y emerges in subchannel SCy. Accordingly, the optical add/drop multiplexer 10 can control subchannels SCx and SCy by using modulated optical signals X and Y, respectively. For example, when modulated optical signal X is generated based on the inverted signal of dropped signal X that is extracted from subchannel SCx, the subcarrier optical signal allocated in subchannel SCx is cancelled by modulated optical signal X. As a result of this, a target subcarrier optical signal is removed from a subcarrier multiplexed optical signal.

When the polarization state of continuous wave light CW1 is controlled so that it is orthogonal to the polarization state of the reference light, the optical add/drop multiplexer 10 generates modulated optical signals X and Y having an optical frequency lower than that of continuous wave light CW1 by Δν as illustrated in FIG. 9D. In addition, the optical add/drop multiplexer 10 makes the polarization state of modulated optical signal X orthogonal to that of the reference light and makes the polarization state of modulated optical signal Y match that of the reference light. Then, idler light x corresponding to modulated optical signal X emerges in subchannel SCx and idler light y corresponding to modulated optical signal Y emerges in subchannel SCy. Accordingly, similarly to the case illustrated in FIG. 9A, the optical add/drop multiplexer 10 can control subchannels SCx and SCy by using modulated optical signals X and Y, respectively.

In the examples illustrated in FIG. 9B and FIG. 9C, subchannels SCx and SCy having an optical frequency lower than that of the reference light by Δν is controlled. Note that the polarization state of subchannel SCx matches that of the reference light and the polarization state of subchannel SCy is orthogonal to that of the reference light.

When the polarization state of continuous wave light CW1 is controlled so that it matches the polarization state of the reference light, the optical add/drop multiplexer 10 generates modulated optical signals X and Y having an optical frequency lower than that of continuous wave light CW1 by Δν as illustrated in FIG. 9B. In addition, the optical add/drop multiplexer 10 makes the polarization state of modulated optical signal X match that of the reference light and makes the polarization state of modulated optical signal Y orthogonal to that of the reference light. Then, idler light x corresponding to modulated optical signal X emerges in subchannel SCx and idler light y corresponding to modulated optical signal Y emerges in subchannel SCy. Accordingly, similarly to the case illustrated in FIG. 9A, the optical add/drop multiplexer 10 can control subchannels SCx and SCy by using modulated optical signals X and Y, respectively.

When the polarization state of continuous wave light CW1 is control so that it is orthogonal to the polarization state of the reference light, the optical add/drop multiplexer 10 generates modulated optical signals X and Y having an optical frequency higher than that of continuous wave light CW1 by Δν as illustrated in FIG. 9C. In addition, the optical add/drop multiplexer 10 makes the polarization state of modulated optical signal X orthogonal to that of the reference light and makes the polarization state of modulated optical signal Y match that of the reference light. Then, idler light x corresponding to modulated optical signal X emerges in subchannel SCx and idler light y corresponding to modulated optical signal Y emerges in subchannel SCy. Accordingly, similarly to the case illustrated in FIG. 9A, the optical add/drop multiplexer 10 can control subchannels SCx and SCy by using modulated optical signals X and Y, respectively.

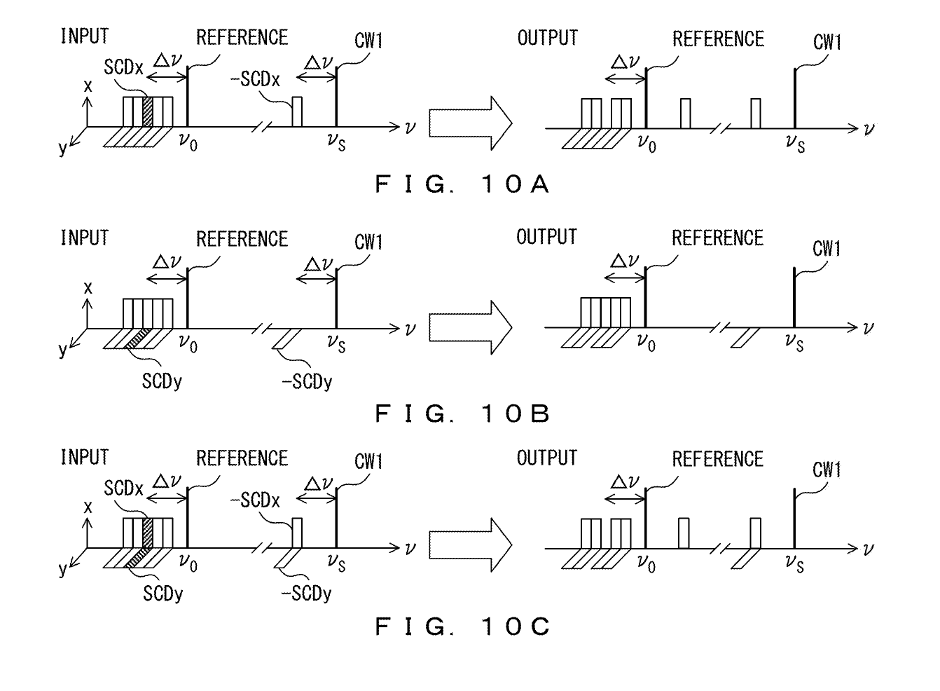

FIGS. 10A-10C, FIGS. 11A-11C and FIGS. 12A-12C illustrate examples of signal processes implemented by the optical add/drop multiplexer 10. It is assumed in the descriptions below that a subchannel is processed by using the non-linear effect illustrated in FIG. 9B. In other words, the optical frequency of the polarization multiplexed optical signal (subcarrier multiplexed optical signals X and Y) is lower than optical frequency of the reference light. In this example, the optical frequency of the reference light is ν₀. Also, the polarization state of continuous wave light CW1 is controlled so that it matches the polarization state of the reference light.

In the example illustrated in FIG. 10A, subcarrier optical signal SCDx is removed from the subcarrier multiplexed optical signal in the X polarization. In this example, the difference in optical frequency between the reference light and subcarrier optical signal SCDx is Δν. In such a case, modulated optical signal X is generated so that the difference in optical frequency between continuous wave light CW1 and modulated optical signal X is Δν. Also, modulated optical signal X is generated so that it represents the inversion of subcarrier optical signal SCDx. Accordingly, modulated optical signal X is denoted by “−SCDx” in FIG. 10A. Further, the polarization state of modulated optical signal X is controlled so that it matches the polarization state of the reference light.

The continuous wave light CW1 and modulated optical signal X are input to the non-linear optical medium 20. Then, idler light corresponding to modulated optical signal X that is shifted from the reference light by Δν in the X polarization (i.e., −SCDx) emerges. Accordingly, subcarrier optical signal SCDx is canceled by the idler light corresponding to modulated optical signal X. In other words, subcarrier optical signal SCDx is removed from the subcarrier multiplexed optical signal in the X polarization.

Note that idler light corresponding to modulated optical signal X emerges also on the high-frequency side of the reference light. Accordingly, the output side of the non-linear optical medium 20 of the optical add/drop multiplexer 10 may be provided with an optical filter that cuts optical frequencies higher than ν₀.

In the example illustrated in FIG. 10B, subcarrier optical signal SCDy is removed from the subcarrier multiplexed optical signal in the Y polarization. In this example, the difference in optical frequency between the reference light and subcarrier optical signal SCDy is Δν. In such a case, modulated optical signal Y is generated so that the difference in optical frequency between continuous wave light CW1 and modulated optical signal Y is Δν. Also, modulated optical signal Y is generated so that it represents the inversion of subcarrier optical signal SCDy. Accordingly, modulated optical signal Y is denoted by “−SCDy” in FIG. 10B. Further, the polarization state of modulated optical signal Y is controlled so that it is orthogonal to the polarization state of the reference light.

The continuous wave light CW1 and modulated optical signal Y are input to the non-linear optical medium 20. Then, idler light corresponding to modulated optical signal Y that is shifted from the reference light by Δν in the Y polarization (i.e., −SCDy) emerges. Accordingly, subcarrier optical signal SCDy is canceled by the idler light corresponding to modulated optical signal Y. In other words, subcarrier optical signal SCDy is removed from the subcarrier multiplexed optical signal in the Y polarization.

In the example illustrated in FIG. 10C, subcarrier optical signals SCDx and SCDy are removed from the subcarrier multiplexed optical signal at the same time. This operation is implemented by inputting continuous wave light CW1, “−SCDx” illustrated in FIG. 10A and “−SCDy” illustrated in FIG. 10B to the non-linear optical medium 20.

Note that the dropping operation by the optical add/drop multiplexer 10 is not limited to the examples illustrated in FIGS. 10A-10C. For example, the optical add/drop multiplexer 10 can simultaneously remove, from a subcarrier multiplexed optical signal, subcarrier optical signals SCDx and SCDy having different frequencies.

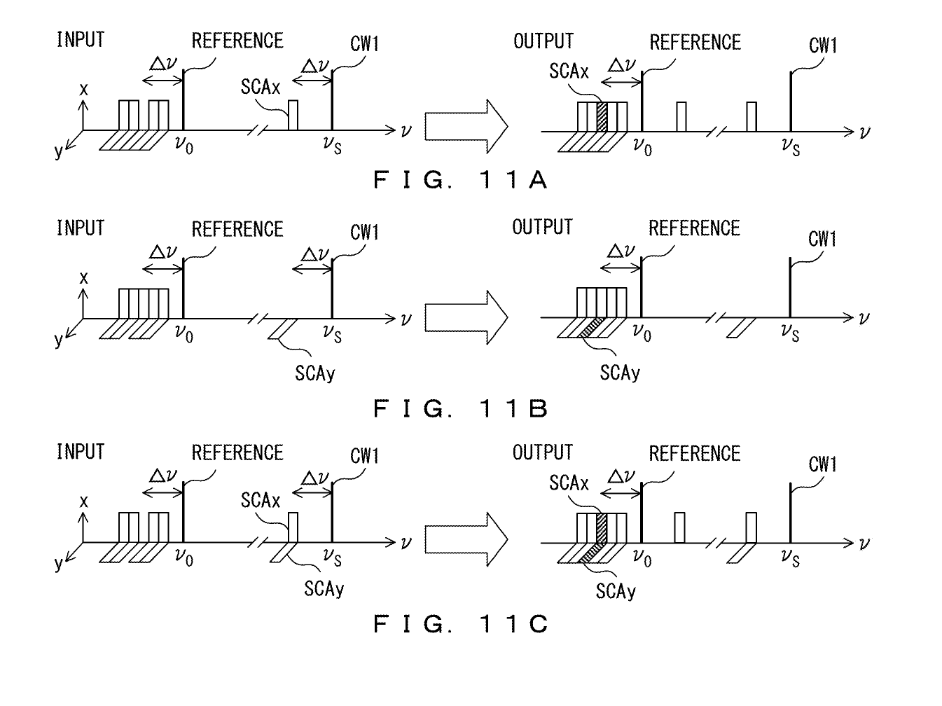

In the example illustrated in FIG. 11A, a subcarrier optical signal is added to the subcarrier multiplexed optical signal in the X polarization. The subchannel to which the subcarrier optical signal is inserted is shifted from the reference light by Δν. In such a case, modulated optical signal X is generated so that the difference in optical frequency between continuous wave light CW1 and modulated optical signal X is Δν. Also, modulated optical signal X is generated so that it represents an add signal. In FIG. 11A, modulated optical signal X is denoted by “SCAx”. Further, the polarization state of modulated optical signal X is controlled so that it matches the polarization state of the reference light.

The continuous wave light CW1 and modulated optical signal X are input to the non-linear optical medium 20. Then, idler light corresponding to modulated optical signal X that is shifted from the reference light by Δν in the X polarization (i.e., SCAx) emerges. In other words, subcarrier optical signal SCAx is added to the subcarrier multiplexed optical signal in the X polarization.

In the example illustrated in FIG. 11B, a subcarrier optical signal is added to the subcarrier multiplexed optical signal in the Y polarization. The subchannel to which the subcarrier optical signal is inserted is shifted from the reference light by Δν. In such a case, modulated optical signal Y is generated so that the difference in optical frequency between continuous wave light CW1 and modulated optical signal Y is Δν. Also, modulated optical signal Y is generated so that it represents an add signal. In FIG. 11B, modulated optical signal Y is denoted by “SCAy”. Further, the polarization state of modulated optical signal Y is controlled so that it is orthogonal to the polarization state of the reference light.

The continuous wave light CW1 and modulated optical signal Y are input to the non-linear optical medium 20. Then, idler light corresponding to modulated optical signal Y that is shifted from the reference light by Δν in the Y polarization (i.e., SCAy) emerges. In other words, subcarrier optical signal SCAy is added to the subcarrier multiplexed optical signal in the Y polarization.

In the example illustrated in FIG. 11C, subcarrier optical signals SCAx and SCAy are added to the subcarrier multiplexed optical signal at the same time. This operation is implemented by inputting continuous wave light CW1, “SCAx” illustrated in FIG. 11A and “SCAy” illustrated in FIG. 11B to the non-linear optical medium 20.

Note that the adding operation by the optical add/drop multiplexer 10 is not limited to the examples illustrated in FIGS. 11A-11C. For example, the optical add/drop multiplexer 10 can simultaneously add, to a subcarrier multiplexed optical signal, subcarrier optical signals SCAx and SCAy having different frequencies.

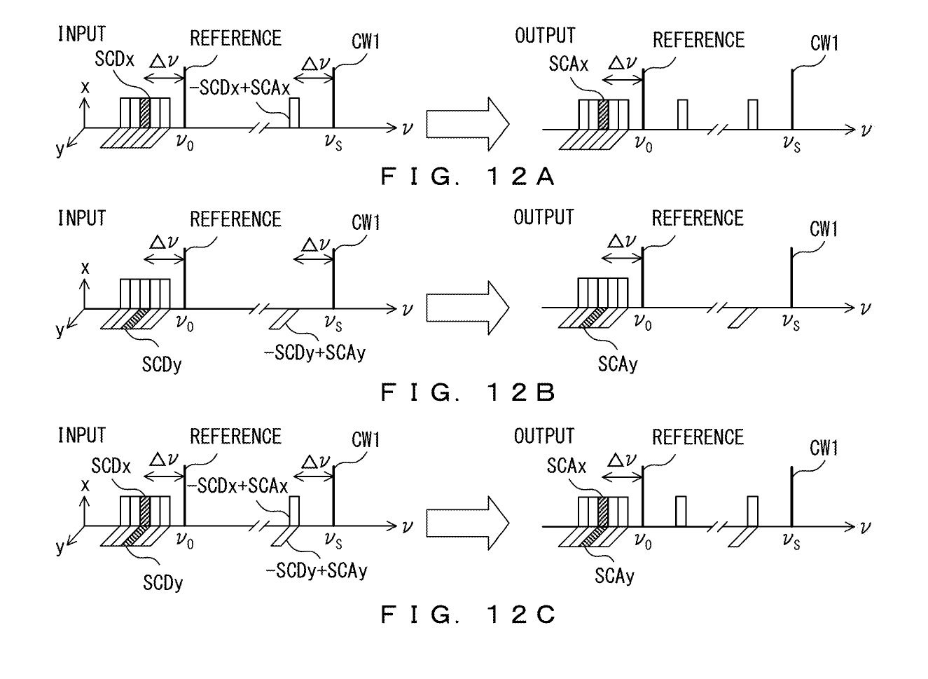

In the example illustrated in FIG. 12A, subcarrier optical signals are replaced in the subcarrier multiplexed optical signal in the X polarization. In other words, subcarrier optical signal SCDx is removed from the subcarrier multiplexed optical signal and subcarrier optical signal SCAx is inserted into the subchannel from which subcarrier optical signal SCDx is removed. That is, subcarrier optical signals are replaced in a subchannel that is shifted from the reference light by Δν. In such a case, modulated optical signal X is generated so that the difference in optical frequency between continuous wave light CW1 and modulated optical signal X is Δν. Also, modulated optical signal X is generated so that it represents the sum of the inverted signal of subcarrier optical signal SCDx, which is to be removed, and subcarrier optical signal SCAx, which is to be inserted. Accordingly, in FIG. 12A, modulated optical signal X is denoted by “−SCDx+SCAx”. Further, the polarization state of modulated optical signal X is controlled so that it matches the polarization state of the reference light.

The continuous wave light CW1 and modulated optical signal X are input to the non-linear optical medium 20. Then, idler light corresponding to modulated optical signal X that is shifted from the reference light by Δν in the X polarization (i.e., −SCDx+SCAx) emerges. Accordingly, subcarrier optical signal SCDx is canceled by the idler light corresponding to modulated optical signal X. Also, subcarrier optical signal SCAx emerges in the subchannel from which subcarrier optical signal SCDx is removed. In other words, subcarrier optical signal SCDx is replaced with subcarrier optical signal SCAx in the subcarrier multiplexed optical signal in the X polarization.

In the example illustrated in FIG. 12B, subcarrier optical signals are replaced in the subcarrier multiplexed optical signal in the Y polarization. In other words, subcarrier optical signal SCDy is removed from the subcarrier multiplexed optical signal and subcarrier optical signal SCAy is inserted into the subchannel from which subcarrier optical signal SCDy is removed. That is, subcarrier optical signals are replaced in a subchannel that is shifted from the reference light by Δν. In such a case, modulated optical signal Y is generated so that the difference in optical frequency between continuous wave light CW1 and modulated optical signal Y is Δν. Also, modulated optical signal Y is generated so that it represents the sum of the inverted signal of subcarrier optical signal SCDy, which is to be removed, and subcarrier optical signal SCAy, which is to be inserted. Accordingly, in FIG. 12B, modulated optical signal Y is denoted by “−SCDy+SCAy”. Further, the polarization state of modulated optical signal Y is controlled so that it is orthogonal to the polarization state of the reference light.

The continuous wave light CW1 and modulated optical signal Y are input to the non-linear optical medium 20. Then, idler light corresponding to modulated optical signal Y that is shifted from the reference light by Δν in the Y polarization (i.e., −SCDy+SCAy) emerges. Accordingly, subcarrier optical signal SCDy is canceled by the idler light corresponding to modulated optical signal Y. Also, subcarrier optical signal SCAy emerges in the subchannel from which subcarrier optical signal SCDy is removed. In other words, subcarrier optical signal SCDy is replaced with subcarrier optical signal SCAy in the subcarrier multiplexed optical signal in the Y polarization.

In the example illustrated in FIG. 12C, the replacement of subcarrier optical signal SCDx with subcarrier optical signal SCAx and the replacement of subcarrier optical signal SCDy with subcarrier optical signal SCAy are performed at the same time. This operation is implemented by inputting continuous wave light CW1, “−SCDx+SCAx” illustrated in FIG. 12A and “−SCDy+SCAy” illustrated in FIG. 12B to the non-linear optical medium 20.

Note that in the optical add/drop multiplexer 10 illustrated in FIG. 3, the polarization estimator 13, the frequency estimator 14, the demodulator 15 and the drive signal generator 16 may be implemented by a processor or a circuit that processes a digital signal. When the receiver 12 includes an FFT circuit, that FFT circuit may also be implemented by a processor or a circuit that processes a digital signal.

As described above, according to the optical add/drop multiplexer 10 of the embodiments of the present invention, adding/dropping of a subcarrier optical signal is implemented by utilizing a difference frequency equivalent to the difference in optical frequency between the reference light and a specified subcarrier optical signal. In this example, the difference frequency is sufficiently lower than the optical frequency of each subcarrier optical signal. Accordingly, it is easy to generate this difference frequency accurately, making it possible to implement adding/dropping of a subcarrier optical signal highly accurately even when the frequency spacing of subcarriers is narrow.

### First Embodiment

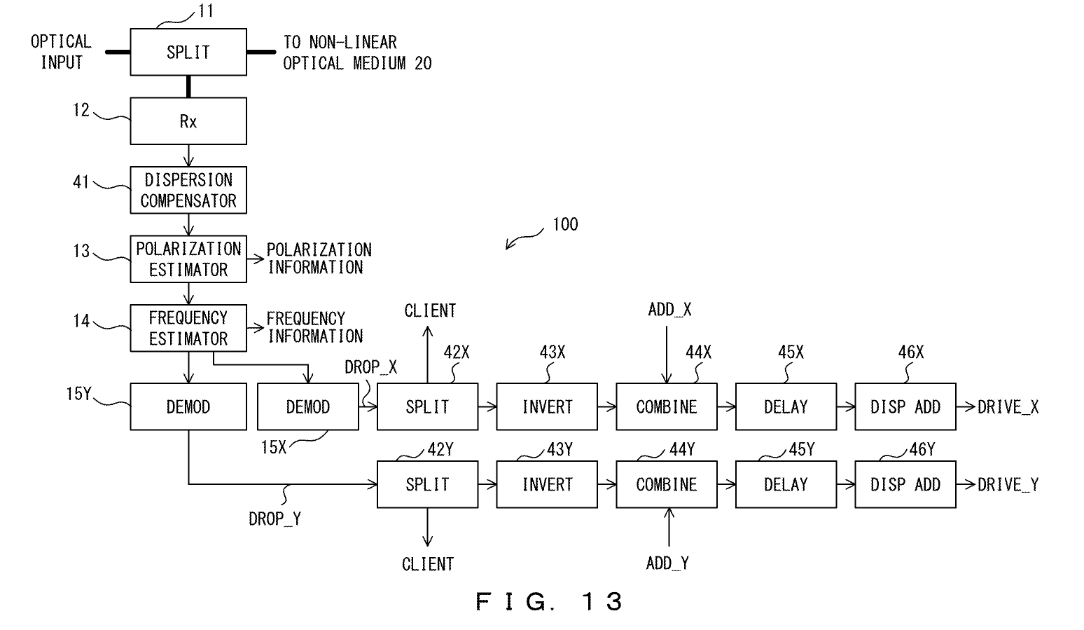

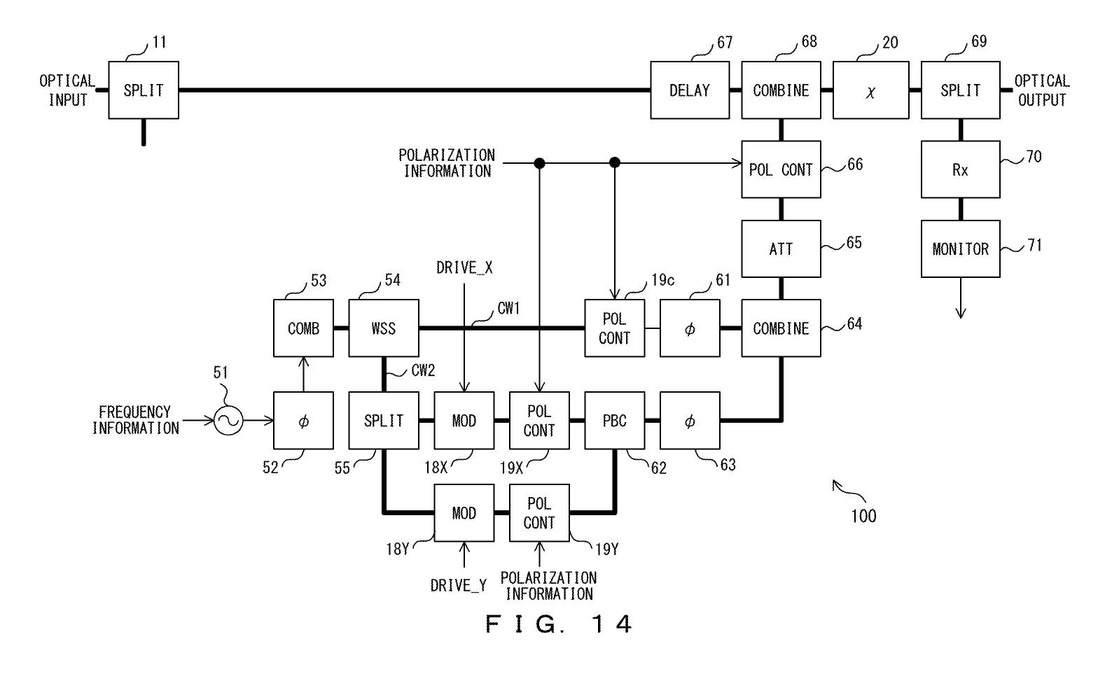

FIG. 13 and FIG. 14 illustrate an example of an optical add/drop multiplexer 100 according to a first embodiment of the present invention. FIG. 13 illustrates an optical receiver circuit and a drive signal generation circuit in the optical add/drop multiplexer 100. FIG. 14 illustrates a light source circuit and an optical signal processing circuit in the optical add/drop multiplexer 100.

The optical receiver circuit in the optical add/drop multiplexer 100 includes the optical splitter 11, the receiver 12, a dispersion compensator 41, polarization estimator 13, a frequency estimator 14, and demodulators 15X and 15Y as illustrated in FIG. 13. The optical splitter 11, the receiver 12, the polarization estimator 13 and the frequency estimator 14 are substantially the same between FIG. 3 and FIG. 13, and thus the explanations thereof will be omitted. Also, the demodulators 15X and 15Y correspond to the demodulator 15 illustrated in FIG. 3. The demodulator 15X demodulates a subcarrier optical signal extracted from the subcarrier multiplexed optical signal in the X polarization so as to output dropped signal X. Similarly, the demodulator 15Y demodulates a subcarrier optical signal extracted from the subcarrier multiplexed optical signal in the Y polarization so as to output dropped signal Y.

The dispersion compensator 41 compensates for an electric signal generated by the receiver 12 so that dispersion added to a subcarrier optical signal is compensated for. Then, the dispersion compensator 41 generates dispersion information representing dispersion that has been compensated for. The compensation for dispersion added to a received optical signal is implemented by a known technology. For example, the dispersion compensator 41 is implemented by a digital filter. In such a case, for example tap coefficients of the digital filter are controlled so that the dispersion is reduced. Also, dispersion information may be generated based on the tap coefficients of the digital filter.

As illustrated in FIG. 13, the drive signal generation circuit includes splitters 42X and 42Y, inverters 43X and 43Y, combiners 44X and 44Y, delay elements 45X and 45Y and dispersion adders 46X and 46Y. Note that the drive signal generation circuit corresponds to the drive signal generator 16 illustrated in FIG. 3.

The splitter 42X guides dropped signal X recovered by the demodulator 15X to the inverter 43X and a client device. The inverter 43X generates the inverted signal of dropped signal X. In the explanations below, the inverted signal of a dropped signal may be referred to as an “inverted dropped signal”. When dropped signal X is expressed by I component and Q component, inverted dropped signal X may be generated by for example inverting the phase of dropped signal X on a constellation. In other words, when dropped signal X is expressed by “I=X1d, Q=X2d”, inverted dropped signal X is expressed by “I=−X1d, Q=−X2d”.

The combiner 44X generates the sum of inverted dropped signal X and add signal X. Note that add signal X is for example a data signal to be added to a subcarrier multiplexed optical signal in the X polarization, and is generated by a client device. When add signal X is expressed by “I=X1a, Q=X2a”, a signal output from the combiner 45b is expressed by “I=−X1d+X1a, Q=−X2d+X2a”.

The delay element 45X delays a signal output from the combiner 44X. A delay time of the delay element 45X is controlled by a monitor circuit 71, which will be described later. The dispersion adders 46X corrects a signal output from the delay element 45X based on the dispersion information given from the dispersion compensator 41. In other words, the dispersion adder 46X adds the dispersion that is compensated for by the dispersion compensator 41 to a signal output from the delay element 45X. Accordingly, the dispersion of a signal output from the dispersion adders 46X is substantially the same as the dispersion of the received optical signal. The signal output from the dispersion adders 46X is given to the optical modulator 18X as drive signal X.

The splitter 42Y, the inverter 43Y, the combiner 44Y, the delay element 45Y and the dispersion adder 46Y are substantially the same as the splitter 42X, the inverter 43X, the combiner 44X, the delay element 45X and the dispersion adder 46X, respectively. In other words, the signal output from the dispersion adder 46Y is fed to the optical modulator 18Y as drive signal Y.

As illustrated in FIG. 14, the light source circuit includes an oscillator 51, a phase shifter 52, an optical frequency comb generator (COMB) 53 and a wavelength selective switch (WSS) 54 and an optical splitter 55. This light source circuit corresponds to the light source circuit 17 illustrated in FIG. 3.

The oscillator 51 generates an oscillation signal in accordance with the frequency information given by the frequency estimator 14. As described above, the frequency information represents difference Δν in optical frequency between the reference light and a specified subcarrier optical signal. In this example, a subcarrier optical signal for which adding and/or dropping is conducted is specified by for example a network management system. The oscillator 51 generates an oscillation signal having a frequency of Δν or Δν/m (m is an integer). Note that a signal output from the oscillator 51 is for example a sine wave. The phase shifter 52 adjusts the phase of a signal output from the oscillator 51 so as to adjust the phase of light output from the optical frequency comb generator 53. The phase shift amount by the phase shifter 52 is controlled by the monitor circuit 71.

The optical frequency comb generator 53 generates an optical frequency comb having optical frequency different from that of the reference light and the input subcarrier multiplexed optical signal in accordance with the oscillation signal whose phase was adjusted by the phase shifter 52. The optical frequency comb generator 53 generates a plurality of continuous wave light beams allocated at specified frequency spacing. The wavelength spacing of the plurality of continuous wave light beams is for example Δν or Δν/m. Alternatively, the spacing of the plurality of continuous wave light beams may be configured in accordance with the symbol rate of the subcarrier multiplexed optical signal.

The wavelength selective switch 54 selects continuous wave light CW1 and continuous wave light CW2 from the optical frequency comb generated by the optical frequency comb generator 53. The optical frequencies of continuous wave light CW1 and continuous wave light CW2 are ν_{B} and ν_{B}−Δν, respectively. In other words, the difference in optical frequency between continuous wave light CW1 and continuous wave light CW2 is Δν. Note that a power of continuous wave light CW1 may be higher than a power of continuous wave light CW2. In such a case, continuous wave light CW1 selected by the wavelength selective switch 54 may be amplified. The optical splitter 55 splits continuous wave light CW2 selected by the wavelength selective switch 54 so as to guide it to the optical modulators 18X and 18Y.

As illustrated in FIG. 14, the optical signal processing circuit includes optical modulators 18X and 18Y, polarization controller 19C, 19X and 19Y, a phase shifter 61, a polarization beam combiner (PBC) 62, a phase shifter 63, an optical combiner 64, an optical attenuator 65, a polarization controller 66, an optical delay line 67, an optical combiner 68, the non-linear optical medium 20, an optical splitter 69, a receiver 70, and the monitor circuit 71. The optical modulators 18X and 18Y, the polarization controllers 19C, 19X and 19Y and the non-linear optical medium 20 are substantially the same between FIG. 3 and FIG. 14.

The polarization controller 19C controls the polarization state of continuous wave light CW1 so that it matches the polarization state of the reference light. The phase shifter 61 controls the optical phase of continuous wave light CW1 output from the polarization controller 19C. The phase shift amount by an optical phase shifter 61 is controlled by the monitor circuit 71.

The optical modulator 18X generates modulated optical signal X by modulating continuous wave light CW1 based on drive signal X. The polarization controller 19X controls the polarization state of modulated optical signal X so that it matches the polarization state of the reference light. The optical modulator 18Y generates modulated optical signal Y by modulating continuous wave light CW2 based on drive signal Y. The polarization controller 19Y controls the polarization state of modulated optical signal Y so that it is orthogonal to the polarization state of the reference light. In other words, modulated optical signals X and Y are controlled so that they have polarization states orthogonal to each other. The polarization beam combiner 62 combines modulated optical signals X and Y so as to generate a polarization multiplexed modulated optical signal.

The optical phase shifter 63 adjusts the optical phase of the polarization multiplexed modulated optical signal. The phase shift amount by the optical phase shifter 63 is controlled by the monitor circuit 71. Note that the optical phases of continuous wave light CW1 and the polarization multiplexed modulated optical signal are adjusted in the example illustrated in FIG. 14, whereas the scope of the present invention is not limited to this configuration. In other words, the optical add/drop multiplexer 100 may include only one of the optical phase shifters 61 and 63. In either case, the optical phases of continuous wave light CW1 and the polarization multiplexed modulated optical signal are made to match each other.

The optical combiner 64 combines continuous wave light CW1 and the polarization multiplexed modulated optical signal. The optical attenuator 65 adjusts the optical power of the combined light output from the optical combiner 64. The attenuation amount by the optical attenuator 65 is controlled by the monitor circuit 71. Based on the polarization information given from the polarization estimator 13, the polarization controller 66 controls the polarization state of the combined light of continuous wave light CW1 and the polarization multiplexed modulated optical signal. In this situation, the polarization controller 66 controls the polarization state of the combined light so that the polarization state of the reference light input to the optical add/drop multiplexer 100 and the polarization state of continuous wave light CW1 match each other. Further, the polarization controller 66 can also control the polarization state of the combined light in accordance with an instruction from the monitor circuit 71.

The optical delay line 67 delays wavelength division multiplexed light guided from the optical splitter 11 to the non-linear optical medium 20. The delay time by the optical delay line 67 is determined based on the time used for the process of demodulating the received optical signal, the process of generating the drive signal, the process of generating the polarization multiplexed modulated optical signal, etc. Specifically, the delay time of the optical delay line 67 may be determined so that the delay time of wavelength division multiplexed light guided from the optical splitter 11 to the non-linear optical medium 20 and the processing time used for generating the polarization multiplexed modulated optical signal in accordance with the wavelength division multiplexed optical signal guided from the optical splitter 11 to the receiver 12 are roughly equal to each other. An optical combiner 68 combines the wavelength division multiplexed light output from the optical delay line 67 and the light output from the polarization controller 66. The light output from the optical combiner 68 is guided to the non-linear optical medium 20.

As a result of this, received wavelength division multiplexed light (reference light and polarization multiplexed optical signal), continuous wave light CW1, modulated optical signal X and modulated optical signal Y are input to the non-linear optical medium 20. Then, a specified subcarrier optical signal is removed from the subcarrier multiplexed optical signal, and a new subcarrier optical signal is added to the subchannel from which the subcarrier optical signal is removed due to the non-linear effect in the non-linear optical medium 20. In other words, the replacement of subcarrier optical signals (dropping and adding) is implemented. Note that the optical add/drop multiplexer 100 may perform only dropping a subcarrier optical signal from a specified channel and may perform only adding a subcarrier optical signal to a specified channel.

The optical splitter 69 splits the wavelength division multiplexed light output from the non-linear optical medium 20 so as to guide the branched portion to the receiver 70. The configuration and the operations of the receiver 70 are substantially the same as those of the receiver 12. However, the receiver 70 may further include the functions of the dispersion compensator 41 and the polarization estimator 13. The receiver 70 generates an electric signal representing the wavelength division multiplexed light output from the non-linear optical medium 20.

Based on a signal output from the receiver 70, the monitor circuit 71 monitors the state of the subcarrier multiplexed optical signal output from the non-linear optical medium 20. Specifically, the monitor circuit 71 monitors the state of the channel from/to which a subcarrier optical signal was dropped/added. Then, the monitor circuit 71 controls the delay elements 45X and 45Y, the phase shifter 52, the optical phase shifters 61 and 63, the optical attenuator 65 and the polarization controller 66. In this control, the monitor circuit 71 controls the delay elements 45X and 45Y, the phase shifter 52, the optical phase shifters 61 and 63, the optical attenuator 65 and the polarization controller 66 so that the monitoring result becomes closer to a specified target state.

Case 1: When a subcarrier optical signal is dropped from a target channel and a new subcarrier optical signal is not added to the target channel, the monitor circuit 71 monitors the optical power of the target channel. Then, the monitor circuit 71 controls the delay elements 45X and 45Y, the phase shifter 52, the optical phase shifters 61 and 63, the optical attenuator 65 and the polarization controller 66 so that the optical power of the target channel becomes lower (so that it becomes closer to zero).

Case 2: When a subcarrier optical signal is dropped from the target channel and a new subcarrier optical signal is added to the target channel, the monitor circuit 71 monitors the optical power and the characteristic of the target channel. Then, the monitor circuit 71 controls the delay elements 45X and 45Y, the phase shifter 52, the optical phase shifters 61 and 63, the optical attenuator 65 and the polarization controller 66 so that the optical power of the target channel becomes roughly the same as the optical power of the other subchannels and that the characteristic of the signal extracted from the target channel (such as the S/N ratio, the error ratio, etc.) satisfies a specified threshold.

By controlling the delay elements 45X and 45Y, the timing error is adjusted between the input wavelength division multiplexed light guided from the optical splitter 11 to the non-linear optical medium 20 and the optical beat signal (continuous wave light CW1 and the polarization multiplexed modulated optical signal). By controlling the phase shifter 52, the phase of the optical frequency comb generated by the optical frequency comb generator 53 is adjusted. As a result of this, the phase synchronization is adjusted between the wavelength division multiplexed light guided from the optical splitter 11 to the non-linear optical medium 20 and the optical beat signal. By controlling the optical phase shifters 61 and 63, the phase of continuous wave light CW1 and the phase of the polarization multiplexed modulated optical signal can be synchronized. By controlling the optical attenuator 65, the optical power of the target channel is adjusted. By controlling the polarization controller 66, the polarization state of a beat optical signal (continuous wave light CW1 and the polarization multiplexed modulated optical signal) is adjusted appropriately with respect to the input wavelength division multiplexed light.

As described above, in the configuration illustrated in FIG. 13 and FIG. 14, the state of a target channel is optimized because the intensity, phase, delay and polarization state of signals are adjusted by the feedback control. Thus, the accuracy of dropping/adding of a subcarrier optical signal increases in each polarization.

Note that while the subcarrier optical signal that is dropped/added in the X polarization and the subcarrier optical signal that is dropped/added in the Y polarization have the same optical frequency in the above described example, the scope of the present invention is not limited to this configuration. In other words, a subcarrier optical signal that is dropped/added in the X polarization and a subcarrier optical signal that is dropped/added in the Y polarization may have different optical frequencies. However, the optical frequency comb generator 53 and the wavelength selective switch 54 generate continuous wave light CW1, CW2 and CW3. The difference in optical frequency between the continuous wave light CW1 and CW2 is equivalent to the difference in optical frequency between the reference light and a subcarrier optical signal that is dropped/added in the X polarization. Also, the difference in optical frequency between the continuous wave light CW1 and CW3 is equivalent to the difference in optical frequency between the reference light and a subcarrier optical signal that is dropped/added in the Y polarization.

While the replacement of subcarrier optical signals is implemented in the examples illustrated in FIG. 13 and FIG. 14, the scope of the present invention is not limited to this operation. Specifically, it is also possible to employ a configuration in which the optical add/drop multiplexer 100 only drops a subcarrier optical signal or only adds a subcarrier optical signal. It is also possible to employ a configuration in which the optical add/drop multiplexer 100 drops, adds or replaces a subcarrier optical signal only one of the X and Y polarizations.

The arrangement of the optical frequencies of the continuous wave light CW1 and CW2 and the polarization states of continuous wave light CW1 and modulated optical signals X and Y with respect to the reference light are exemplary, and the scope of the present invention is not limited to these examples. Specifically, the optical add/drop multiplexer 100 can generate continuous wave light and a modulated optical signal in various patterns including those in the examples illustrated in FIGS. 9A-9D.

### Second Embodiment

In the configurations illustrated in FIG. 13 and FIG. 14, a channel from which an optical signal is dropped and a channel to which an optical signal is added are the same. In other words, an optical signal is dropped from a target channel and a new optical signal is added to that target channel.

By contract, an optical add/drop multiplexer according to a second embodiment can add an optical signal to a desired unoccupied channel. In other words, a channel from which an optical signal is dropped and a channel to which an optical signal is added may be the same or may be different.

Note that the configurations and the operations of the optical receiver circuit (e.g., the optical splitter 11, the receiver 12, the dispersion compensator 41, the polarization estimator 13, the frequency estimator 14 and the demodulators 15X and 15Y illustrated in FIG. 13) are substantially the same between the first and second embodiments. Thus, the explanations for the optical receiver circuit will be omitted.

The configurations and the operations of the drive signal generation circuit are similar between the first and second embodiments. However, in the second embodiment, a drive signal for cancelling a dropped signal and a drive signal for representing an add signal are not combined with each other.

Drive signals X and Y are generated by the splitters 42X and 42Y, the inverters 43X and 43Y, the delay elements 45X and 45Y and the dispersion adders 46X and 46Y, respectively. In other words, each of the drive signals X and Y does not include an add signal component. Drive signals X and Y are respectively given to optical modulators 18DX and 18DY, which will be explained later. Meanwhile, add signals X and Y are respectively given, as drive signals, to optical modulators 18AX and 18AY, which will be explained later. Note that dispersion compensated for by the dispersion compensator 41 is added to add signals X and Y by the functions equivalent to those of the dispersion adders 46X and 46Y.

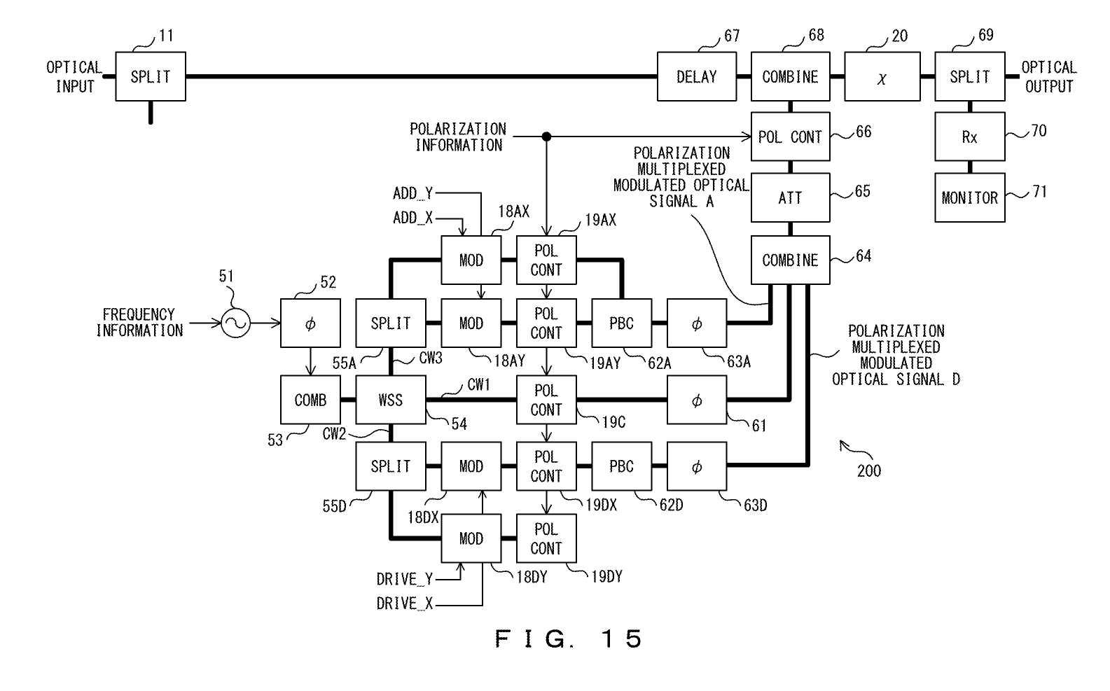

FIG. 15 illustrates an example of an optical add/drop multiplexer 200 according to the second embodiment of the present invention. FIG. 15 illustrates a light source circuit and an optical signal processing circuit of the optical add/drop multiplexer 200. In other words, the optical receiver circuit and the drive signal generation circuit are omitted in FIG. 15.

The light source circuit of the optical add/drop multiplexer according to the second embodiment includes the oscillator 51, the phase shifter 52, the optical frequency comb generator 53, the wavelength selective switch 54, and the optical splitters 55D and 55A as illustrated in FIG. 15. The oscillator 51, the phase shifter 52 and the optical frequency comb generator 53 are substantially the same between the first and second embodiments.

The wavelength selective switch 54 generates continuous wave light CW1-CW3 from the optical frequency comb generated by the optical frequency comb generator 53. Continuous wave light CW1 and continuous wave light CW2 are the same as those in the first embodiment. In other words, the difference in optical frequency between continuous wave light CW1 and continuous wave light CW2 is equal to the difference in optical frequency between the reference light and the subcarrier optical signal that is to be dropped. Also, the difference in optical frequency between continuous wave light CW1 and continuous wave light CW3 is equal to the difference in optical frequency between the reference light and the subchannel to which the add signal is to be added.

The optical splitter 55D splits continuous wave light CW2 output from the wavelength selective switch 54 so as to guide the branched portions to the optical modulators 18DX and 18DY. Also, the optical splitter 55A splits continuous wave light CW3 output from the wavelength selective switch 54 so as to guide the branched portions to the optical modulators 18AX and 18AY.

As illustrated in FIG. 15, the optical signal processing circuit includes the optical modulators 18DX, 18DY, 18AX and 18AY, the polarization controllers 19C, 19DX, 19DY, 19AX and 19AY, the polarization beam combiners 62D and 62A, the optical phase shifters 61, 63D and 63A, the optical combiner 64, the optical attenuator 65, the polarization controller 66, the optical delay line 67, the optical combiner 68, the non-linear optical medium 20, the optical splitter 69, the receiver 70 and the monitor circuit 71. The polarization controller 19C, the phase shifter 61, the optical attenuator 65, the polarization controller 66, the optical delay line 67, the optical combiner 68, the non-linear optical medium. 20, the optical splitter 69, the receiver 70 and the monitor circuit 71 are substantially the same between the first and second embodiments.

The optical modulator 18DX drives continuous wave light CW2 with drive signal X so as to generate modulated optical signal DX. The optical modulator 18DY drives continuous wave light CW2 with drive signal Y so as to generate modulated optical signal DY. The optical modulator 18AX drives continuous wave light CW3 with add signal X so as to generate modulated optical signal AX. The optical modulator 18AY drives continuous wave light CW3 with add signal Y so as to generate modulated optical signal AY.

The polarization controllers 19DX, 19DY, 19AX and 19AY respectively control the polarization states of the modulated optical signals DX, DY, AX and AY based on the polarization information. In this example, the polarization states of modulated optical signals DX and AX are controlled so that they match the polarization state of the reference light. Also, the polarization states of modulated optical signals DY and AY are controlled so that they are orthogonal to the polarization state of the reference light.

The polarization beam combiner 62D combines modulated optical signals DX and DY that are output from the polarization controllers 19DX and 19DY so as to generate polarization multiplexed modulated optical signal D. The optical phase shifter 63D adjusts the phase of polarization multiplexed modulated optical signal D in accordance with the control by the monitor circuit 71. Similarly, the polarization beam combiner 62A combines modulated optical signals AX and AY that are output from the polarization controllers 19AX and 19AY so as to generate polarization multiplexed modulated optical signal A. The optical phase shifter 63A adjusts the phase of polarization multiplexed modulated optical signal A in accordance with the control by the monitor circuit 71.

The optical combiner 64 combines continuous wave light CW1, polarization multiplexed modulated optical signal D and polarization multiplexed modulated optical signal A so as to generate optical beat signals. The optical beat signals are guided to the non-linear optical medium 20 via the optical attenuator 65, the polarization controller 66 and the optical combiner 68. In other words, the received wavelength division multiplexed light (reference light and subcarrier multiplexed optical signal), continuous wave light CW1, polarization multiplexed modulated optical signal D and polarization multiplexed modulated optical signal A are input to the non-linear optical medium 20.

In the above configuration, when the received wavelength division multiplexed light, continuous wave light CW1 and polarization multiplexed modulated optical signal Dare input to the non-linear optical medium 20, the dropping operation illustrated in FIG. 10C is implemented. Also, the received wavelength division multiplexed light, continuous wave light CW1 and polarization multiplexed modulated optical signal A are input to the non-linear optical medium 20, the adding operation illustrated in FIG. 11C is implemented. A subchannel from which a subcarrier optical signal is dropped is specified by the difference in optical frequency between the continuous wave light CW1 and CW2, and a subchannel to which a subcarrier optical signal is added is specified by the difference in optical frequency between the continuous wave light CW1 and CW3. Thus, the optical add/drop multiplexer 200 can add a subcarrier optical signal to a desired unoccupied subchannel. When continuous wave light CW2 and CW3 have the same optical frequency, the replacement illustrated in FIG. 12 is implemented.

Note that subcarrier optical signals are replaced in each polarization in the example illustrated in FIG. 15, while the scope of the present invention is not limited to this configuration. Specifically, a channel from which a signal is dropped and a channel to which a signal is added may be different in each polarization. In such a case, however, the optical frequency comb generator 53 and the wavelength selective switch 54 generate continuous wave light CW1-CW5. The difference in optical frequency between the continuous wave light CW1 and CW2 is equivalent to the difference in optical frequency between the reference light and the subcarrier optical signal that is dropped in the X polarization. The difference in optical frequency between the continuous wave light CW1 and CW3 is equivalent to the difference in optical frequency between the reference light and the subcarrier optical signal that is dropped in the Y polarization. The difference in optical frequency between the continuous wave light CW1 and CW4 is equivalent to the difference in optical frequency between the reference light and the subcarrier optical signal that is added in the Y polarization. The difference in optical frequency between the continuous wave light CW1 and CW5 is equivalent to the difference in optical frequency between the reference light and the subcarrier optical signal that is added in the Y polarization.

### Third Embodiment

In the first and second embodiments, optical beat signals are generated based on a dropped signal and an add signal, and the drooping and adding of optical signals are implemented by inputting such optical beat signals to a non-linear optical medium. An optical add/drop multiplexer according to a third embodiment drops/adds optical signals based on an effect different from that in the first and second embodiments.

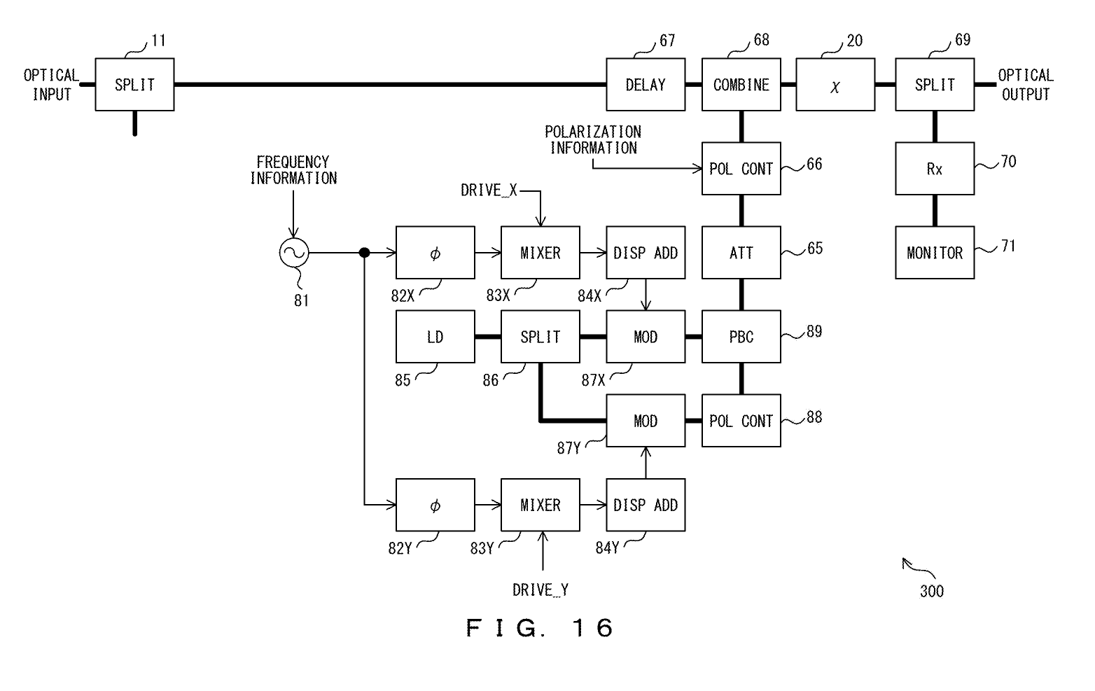

FIG. 16 illustrates an optical add/drop multiplexer 300 according to the third embodiment of the present invention. The optical receiver circuits and the drive signal generation circuits are substantially the same between the first and third embodiment. Specifically, the optical receiver circuit and the drive signal generation circuit illustrated in FIG. 13 generate frequency information, polarization information and drive signals X and Y in the third embodiment similarly to the first embodiment.

An oscillator 81 outputs an oscillation signal in accordance with the frequency information given from the frequency estimator 14. In this example, frequency information represents difference Δν in optical frequency between the reference light and the subcarrier optical signal that is to be removed from the input subcarrier multiplexed optical signal. The oscillator 81 outputs an oscillation signal of frequency Δν. Phase shifters 82X and 82Y respectively adjust the phases of oscillation signals output from the oscillator 81. The phase shift amounts by the phase shifters 82X and 82Y are controlled by the monitor circuit 71.

A mixer 83X mixes the oscillation signal adjusted by the phase shifter 82X and drive signal X. Drive signal X is generated based on inverted dropped signal X corresponding to dropped signal X that is dropped from the subcarrier multiplexed optical signal in the X polarization and add signal X that is added to the subcarrier multiplexed optical signal in the X polarization. Accordingly, a signal output from the mixer 83X can be expressed by the formula below.

(B_{XA}−B_{XD})cos(2πΔνt)

B_{XD} represents dropped signal X. Thus, −B_{XD} represents inverted dropped signal X. B_{XA} represents add signal X.

Similarly, a mixer 83Y mixes the oscillation signal adjusted by the phase shifter 82Y and drive signal Y. Drive signal Y is generated based on inverted dropped signal Y corresponding to dropped signal Y that is dropped from the subcarrier multiplexed optical signal in the Y polarization and add signal Y that is added to the subcarrier multiplexed optical signal in the Y polarization. Accordingly, a signal output from the mixer 83Y can be expressed by the formula below.

(B_{YA}−B_{YD})cos(2Δνt)

B_{YD} represents dropped signal Y. Thus, −B_{YD} represents inverted dropped signal Y. B_{YA} represents add signal Y.

Similarly to the dispersion adder 46X, a dispersion adder 84X corrects a signal output from the mixer 83X based on the dispersion information given from the dispersion compensator 41. Also, similarly to the dispersion adder 46Y, a dispersion adder 84Y corrects a signal output from the mixer 83Y based on the dispersion given from the dispersion compensator 41.

A light source 85 generates continuous wave light. The optical frequency of this continuous wave light is not limited particularly. However, the optical frequency of the continuous wave light is different from the optical frequency of the reference light and is also different from the optical frequency of the input subcarrier multiplexed optical signal. The continuous wave light is split by the optical splitter 86 and guided to optical modulators 87X and 87Y.

The optical modulator 87X modulates the continuous wave light with a signal output from the dispersion adder 84X so as to generate modulated optical signal X. The optical modulator 87Y modulates the continuous wave light with a signal output from the dispersion adder 84Y so as to generate modulated optical signal Y. A polarization controller 88 controls the polarization state of modulated optical signal Y so that the polarization states of modulated optical signals X and Y are orthogonal to each other. A polarization beam combiner 89 combines modulated optical signals X and Y so as to generate a polarization multiplexed modulated optical signal.

The polarization state of the polarization multiplexed modulated optical signal is controlled by the polarization controller 66. Specifically, based on the polarization information generated by the polarization estimator 13, the polarization controller 66 controls the polarization state of the polarization multiplexed modulated optical signal so that the polarization state of X polarization component (i.e., modulated optical signal X) of the polarization multiplexed modulated optical signal matches that of the reference light and that the polarization state of the Y polarization component (i.e., modulated optical signal Y) of the polarization multiplexed modulated optical signal is orthogonal to that of the reference light. Thereafter, the polarization multiplexed modulated optical signal is guided by the optical combiner 68 to the non-linear optical medium 20. Thus, the input wavelength division multiplexed light (reference light and polarization multiplexed optical signal), the polarization multiplexed modulated optical signal (modulated optical signal X and modulated optical signal Y) are input to the non-linear optical medium 20.

In this example, the input wavelength division multiplexed light includes the reference light and subcarrier multiplexed optical signals X and Y as illustrated in FIG. 4. The polarization multiplexed modulated optical signal is generated by utilizing an oscillation signal having the frequency of Δν and continuous wave light generated by the light source 85. Accordingly, the non-linear effects generates “B_{XA}−B_{XD}” at the optical frequency that is shifted from the reference light by Δν in the X polarization, and also generates “B_{YA}−B_{YD}” at the optical frequency that is shifted from the reference light by Δν in the Y polarization. Accordingly, also in the third embodiment, due to an effect similar to those in FIGS. 12A-12C, a specified subcarrier optical signal is removed from each polarization component of the subcarrier multiplexed optical signal, and a subcarrier optical signal is added to each polarization component of the subcarrier multiplexed optical signal.

In above examples, a channel from which an optical signal is dropped and a channel to which an optical signal is added are the same, however, the third embodiment is not limited to this configuration. That is, the optical add/drop multiplexer according to the third embodiment may add an optical signal to an arbitrary unoccupied channel.

### Fourth Embodiment

In a fourth embodiment, an electric signal representing a subcarrier optical signal that is dropped/added in the X polarization and an electric signal representing a subcarrier optical signal that is dropped/added in the Y polarization are combined based on the polarization state of an input signal.

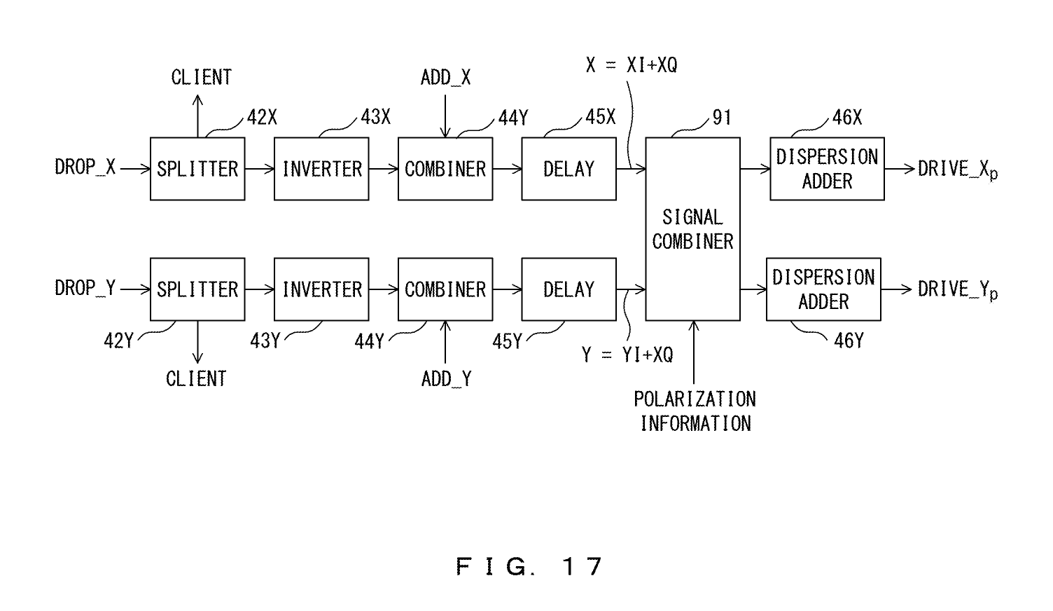

FIG. 17 illustrates an example of a drive signal generation circuit used in the optical add/drop multiplexer of the fourth embodiment. The drive signal generation circuit of the fourth embodiment includes a signal combiner 91 in addition to the splitters 42X, 42Y, the inverters 43X and 43Y, the combiners 44X and 44Y, the delay elements 45X and 45Y and the dispersion adders 46X and 46Y illustrated in FIG. 13.

Drive signals X and Y are input to the signal combiner 91. In this example, it is assumed that drive signals X and Y are respectively represented by I and Q components as described below, where QX and QY are imaginary numbers.

X=IX+QX

Y=IY+QY

Polarization information generated by the polarization estimator 13 is given to the signal combiner 91. The polarization information is assumed to represent angle θ illustrated in FIG. 6. In such a case, the signal combiner 91 performs the calculations below.

$$\begin{matrix}{X}_{P} = ( IX + QX ) cos θ - ( IY + QY ) sin θ \\ = ( IX cos θ - IY sin θ ) + ( QX cos θ - QY sin θ )\end{matrix}$$

$$\begin{matrix}{Y}_{P} = ( IX + QX ) sin θ + ( IY + QY ) cos θ \\ = ( IX sin θ + IY cos θ ) + ( QX sin θ + QY cos θ )\end{matrix}$$

Then, the signal combiner 91 outputs combined signals X_{P} and Y_{P}.

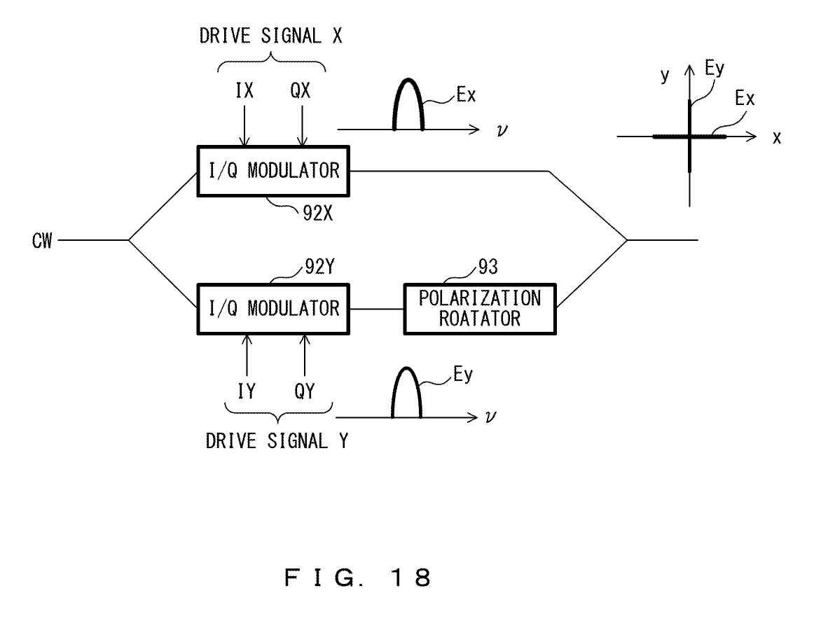

FIG. 18 illustrates an example of polarization multiplexing. When a polarization multiplexed modulated optical signal is generated from modulated optical signal X, which represents drive signal X, and modulated optical signal Y, which represents drive signal Y, modulated optical signal X is generated from drive signal X by using an optical I/Q modulator 92X and modulated optical signal Y is generated from drive signal Y by using an optical I/Q modulator 92Y, as illustrated in FIG. 18. Also, a polarization rotator 93 rotates the polarization state of one of the modulated optical signals X and Y by 90 degrees. In the example illustrated in FIG. 18, the polarization state of modulated optical signal Y is rotated by 90 degrees. By combining modulated optical signal X and modulated optical signal Y whose polarization state has been controlled, a polarization multiplexed modulated optical signal is generated.

However, the polarization state of polarization multiplexed light rotates on a transmission path. In response to this, the optical add/drop multiplexer estimates the polarization state of input light so as to generate a polarization multiplexed modulated optical signal in accordance with the estimation result. It is assumed in this example that angle θ illustrated in FIG. 6 is obtained by the polarization estimator 13. In such a case, the drive signal generation circuit of the fourth embodiment combines drive signals X and Y so that a polarization multiplexed optical signal whose polarization is rotated by angle θ with respect to the state illustrated in FIG. 18 is generated. In other words, the signal combiner 91 generates above drive signals X_{P} and Y_{P} from drive signals X and Y.

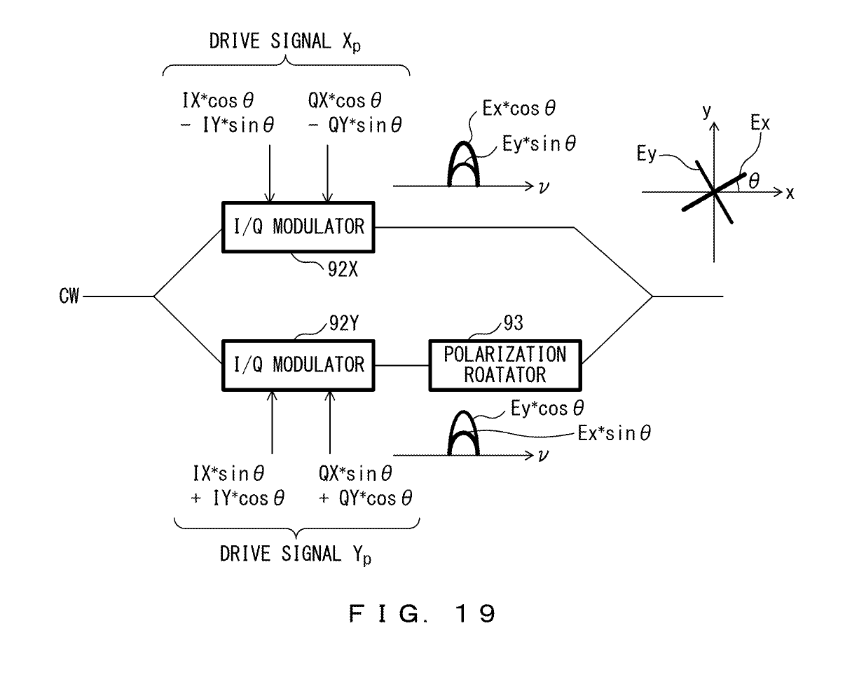

FIG. 19 illustrates an example of polarization combining based on drive signals. In this example, the optical I/Q modulator 92X generates a modulated optical signal by modulating continuous wave light CW by using combined signal X_{P}, and the optical I/Q modulator 92Y generates a modulated optical signal by modulating continuous wave light CW by using combined signal Y_{P}. Then, the polarization of the modulated optical signal output from the optical I/Q modulator 92Y is rotated by 90 degrees. As a result of this, a polarization multiplexed modulated optical signal whose polarization is rotated by angle θ with respect to a specified polarization axis is generated.

In the fourth embodiment as described above, drive signals X and Y are combined in the electric domain based on polarization information, and thereby a polarization multiplexed modulated optical signal in accordance with the polarization state the input light is generated. Accordingly, when for example the drive signal generation circuit according to the fourth embodiment is applied to the optical add/drop multiplexer according to the first embodiment, the optical I/Q modulators 92X and 92Y and the polarization rotator 93 illustrated in FIG. 19 are used in place of the optical modulators 18X and 18Y and the polarization controllers 19X and 19Y illustrated in FIG. 14. Note that the drive signal generation circuit according to the fourth embodiment can be applied to the second and third embodiments as well.

### Other Embodiments

In the above examples, the optical add/drop multiplexer processes a subcarrier multiplexed optical signal in which a plurality of subcarrier optical signal are multiplexed. In other words, in the above examples, a subcarrier optical signal is dropped from a subcarrier multiplexed optical signal and another subcarrier optical signal is added to the subcarrier multiplexed optical signal.

The scope of the present invention is not limited to this configuration. For example, the optical add/drop multiplexer may employ a configuration in which an optical signal of a specified wavelength channel is dropped from a WDM optical signal and an optical signal is added to a desired wavelength channel in the WDM optical signal. However, in this case, it is preferable that the phases of the respective wavelength channels in the WDM optical signal be synchronized.

Note that when a subcarrier multiplexed optical signal is generated by modulating continuous wave light output from one laser light source, the phases of a plurality of subcarrier optical signals multiplexed in the subcarrier multiplexed optical signal are synchronized. Accordingly, a subcarrier multiplexed optical signal is an example of a wavelength division multiplexed optical signal in which phases are synchronized.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical add/drop multiplexer that processes wavelength division multiplexed light containing reference light and a polarization multiplexed optical signal in which a first wavelength division multiplexed optical signal transmitted in a first polarization and a second wavelength division multiplexed optical signal transmitted in a second polarization are multiplexed, the first polarization and the second polarization being orthogonal to each other, the optical add/drop multiplexer comprising:
an optical splitter configured to split the wavelength division multiplexed light to generate first wavelength division multiplexed light and second wavelength division multiplexed light;
a receiver configured to generate an electric signal from the second wavelength division multiplexed light by coherent detection;
a polarization estimator configured to estimate a polarization state of the wavelength division multiplexed light based on the electric signal;
a light source configured to generate first oscillation light and second oscillation light, an optical frequency of the second oscillation light being different from an optical frequency of the first oscillation light;
a drive signal generator configured to generate a drive signal based on at least one of a dropped signal corresponding to an optical signal dropped from the first wavelength division multiplexed optical signal and an add signal corresponding to an optical signal to be added to the first wavelength division multiplexed optical signal;
an optical modulator configured to modulate the second oscillation light in accordance with the drive signal to generate a modulated optical signal;
a polarization controller configured to control a polarization state of the first oscillation light and the modulated optical signal based on the polarization state estimated by the polarization estimator; and
a non-linear optical medium to which the first wavelength division multiplexed light, the first oscillation light whose polarization state is controlled by the polarization controller, and the modulated optical signal whose polarization state is controlled by the polarization controller are input.

2. The optical add/drop multiplexer according to claim 1, wherein
the polarization controller controls the polarization state of the first oscillation light so that the polarization state of the first oscillation light matches or is orthogonal to the polarization state of the reference light and controls the polarization state of the modulated optical signal so that the polarization state of the modulated optical signal matches or is orthogonal to the polarization state of the first wavelength division multiplexed optical signal, based on the polarization state estimated by the polarization estimator.

3. The optical add/drop multiplexer according to claim 2, wherein
the polarization state of the first wavelength division multiplexed optical signal matches the polarization state of the reference light,
an optical frequency of the first wavelength division multiplexed optical signal is lower than an optical frequency of the reference light,
the light source generates the first oscillation light and the second oscillation light so that the optical frequency of the second oscillation light is lower than the optical frequency of the first oscillation light by a specified amount, and
the polarization controller controls the polarization state of the first oscillation light so that the polarization state of the first oscillation light matches the polarization state of the reference light and controls the polarization state of the modulated optical signal so that the polarization state of the modulated optical signal matches the polarization state of the first wavelength division multiplexed optical signal, based on the polarization state estimated by the polarization estimator.

4. The optical add/drop multiplexer according to claim 2, wherein
the polarization state of the first wavelength division multiplexed optical signal matches the polarization state of the reference light,
an optical frequency of the first wavelength division multiplexed optical signal is lower than an optical frequency of the reference light,
the light source generates the first oscillation light and the second oscillation light so that the optical frequency of the second oscillation light is higher than the optical frequency of the first oscillation light by a specified amount, and
the polarization controller controls the polarization state of the first oscillation light so that the polarization state of the first oscillation light is orthogonal to the polarization state of the reference light and controls the polarization state of the modulated optical signal so that the polarization state of the modulated optical signal is orthogonal to the polarization state of the first wavelength division multiplexed optical signal, based on the polarization state estimated by the polarization estimator.

5. The optical add/drop multiplexer according to claim 2, wherein
the polarization state of the first wavelength division multiplexed optical signal is orthogonal to the polarization state of the reference light,
an optical frequency of the first wavelength division multiplexed optical signal is lower than an optical frequency of the reference light,
the light source generates the first oscillation light and the second oscillation light so that the optical frequency of the second oscillation light is lower than the optical frequency of the first oscillation light by a specified amount, and
the polarization controller controls the polarization state of the first oscillation light so that the polarization state of the first oscillation light matches the polarization state of the reference light and controls the polarization state of the modulated optical signal so that the polarization state of the modulated optical signal is orthogonal to the polarization state of the first wavelength division multiplexed optical signal, based on the polarization state estimated by the polarization estimator.

6. The optical add/drop multiplexer according to claim 2, wherein
the polarization state of the first wavelength division multiplexed optical signal is orthogonal to the polarization state of the reference light,
an optical frequency of the first wavelength division multiplexed optical signal is lower than an optical frequency of the reference light,
the light source generates the first oscillation light and the second oscillation light so that the optical frequency of the second oscillation light is higher than the optical frequency of the first oscillation light by a specified amount, and
the polarization controller controls the polarization state of the first oscillation light so that the polarization state of the first oscillation light is orthogonal to the polarization state of the reference light and controls the polarization state of the modulated optical signal so that the polarization state of the modulated optical signal matches the polarization state of the first wavelength division multiplexed optical signal, based on the polarization state estimated by the polarization estimator.

7. The optical add/drop multiplexer according to claim 2, wherein
the polarization state of the first wavelength division multiplexed optical signal matches the polarization state of the reference light,
an optical frequency of the first wavelength division multiplexed optical signal is higher than an optical frequency of the reference light,
the light source generates the first oscillation light and the second oscillation light so that the optical frequency of the second oscillation light is higher than the optical frequency of the first oscillation light by a specified amount, and
the polarization controller controls the polarization state of the first oscillation light so that the polarization state of the first oscillation light matches the polarization state of the reference light and controls the polarization state of the modulated optical signal so that the polarization state of the modulated optical signal matches the polarization state of the first wavelength division multiplexed optical signal, based on the polarization state estimated by the polarization estimator.

8. The optical add/drop multiplexer according to claim 2, wherein
the polarization state of the first wavelength division multiplexed optical signal matches the polarization state of the reference light,
an optical frequency of the first wavelength division multiplexed optical signal is higher than an optical frequency of the reference light,
the light source generates the first oscillation light and the second oscillation light so that the optical frequency of the second oscillation light is lower than the optical frequency of the first oscillation light by a specified amount, and
the polarization controller controls the polarization state of the first oscillation light so that the polarization state of the first oscillation light is orthogonal to the polarization state of the reference light and controls the polarization state of the modulated optical signal so that the polarization state of the modulated optical signal is orthogonal to the polarization state of the first wavelength division multiplexed optical signal, based on the polarization state estimated by the polarization estimator.

9. The optical add/drop multiplexer according to claim 2, wherein
the polarization state of the first wavelength division multiplexed optical signal is orthogonal to the polarization state of the reference light,
an optical frequency of the first wavelength division multiplexed optical signal is higher than an optical frequency of the reference light,
the light source generates the first oscillation light and the second oscillation light so that the optical frequency of the second oscillation light is higher than the optical frequency of the first oscillation light by a specified amount, and
the polarization controller controls the polarization state of the first oscillation light so that the polarization state of the first oscillation light matches the polarization state of the reference light and controls the polarization state of the modulated optical signal so that the polarization state of the modulated optical signal is orthogonal to the polarization state of the first wavelength division multiplexed optical signal, based on the polarization state estimated by the polarization estimator.

10. The optical add/drop multiplexer according to claim 2, wherein
the polarization state of the first wavelength division multiplexed optical signal is orthogonal to the polarization state of the reference light,
an optical frequency of the first wavelength division multiplexed optical signal is higher than an optical frequency of the reference light,
the light source generates the first oscillation light and the second oscillation light so that the optical frequency of the second oscillation light is lower than the optical frequency of the first oscillation light by a specified amount, and
the polarization controller controls the polarization state of the first oscillation light so that the polarization state of the first oscillation light is orthogonal to the polarization state of the reference light and controls the polarization state of the modulated optical signal so that the polarization state of the modulated optical signal matches the polarization state of the first wavelength division multiplexed optical signal, based on the polarization state estimated by the polarization estimator.

11. The optical add/drop multiplexer according to claim 1, wherein
a difference in optical frequency between the first oscillation light and the second oscillation light is substantially equal to a difference in optical frequency between the reference light and an optical signal dropped from the first wavelength division multiplexed optical signal, and
the drive signal generator generates the drive signal based on an inverted signal of the dropped signal.

12. The optical add/drop multiplexer according to claim 11, wherein
the drive signal generator generates the drive signal based on a sum of the inverted signal of the dropped signal and the add signal.

13. The optical add/drop multiplexer according to claim 1 further comprising
a frequency estimator configured to estimate a difference in optical frequency between the reference light and an optical signal dropped from the first wavelength division multiplexed optical signal, based on the electric signal, wherein
the difference in optical frequency between the first oscillation light and the second oscillation light is substantially equal to the difference estimated by the frequency estimator.

14. An optical add/drop multiplexer that processes wavelength division multiplexed light containing reference light and a polarization multiplexed optical signal in which a first wavelength division multiplexed optical signal transmitted in a first polarization and a second wavelength division multiplexed optical signal transmitted in a second polarization are multiplexed, the first polarization and the second polarization being orthogonal to each other, the optical add/drop multiplexer comprising:
an optical splitter configured to split the wavelength division multiplexed light to generate first wavelength division multiplexed light and second wavelength division multiplexed light;
a receiver configured to generate an electric signal from the second wavelength division multiplexed light by coherent detection;
a polarization estimator configured to estimate a polarization state of the wavelength division multiplexed light based on the electric signal;
a light source configured to generate first oscillation light, second oscillation light and third oscillation light, optical frequencies of the second oscillation light and the third oscillation light being different from an optical frequency of the first oscillation light;
a drive signal generator configured to generate a first drive signal and a second drive signal respectively based on a first dropped signal corresponding to an optical signal dropped from the first wavelength division multiplexed optical signal and a second dropped signal corresponding to an optical signal dropped from the second wavelength division multiplexed optical signal;
a first optical modulator configured to modulate the second oscillation light in accordance with the first drive signal to generate a first modulated optical signal;
a second optical modulator configured to modulate the third oscillation light in accordance with the second drive signal to generate a second modulated optical signal;
a polarization controller configured to control polarization states of the first oscillation light, the first modulated optical signal and the second modulated optical signal based on the polarization state estimated by the polarization estimator; and
a non-linear optical medium to which the first wavelength division multiplexed light, the first oscillation light whose polarization state is controlled by the polarization controller and the first and second modulated optical signals whose polarization states are controlled by the polarization controller are input.

15. An optical add/drop multiplexer that processes wavelength division multiplexed light containing reference light and a polarization multiplexed optical signal in which a first wavelength division multiplexed optical signal transmitted in a first polarization and a second wavelength division multiplexed optical signal transmitted in a second polarization are multiplexed, the first polarization and the second polarization being orthogonal to each other, the optical add/drop multiplexer comprising:
an optical splitter configured to split the wavelength division multiplexed light to generate first wavelength division multiplexed light and second wavelength division multiplexed light;
a receiver configured to generate an electric signal from the second wavelength division multiplexed light by coherent detection;
a polarization estimator configured to estimate a polarization state of the wavelength division multiplexed light based on the electric signal;
a light source configured to generate first through fifth oscillation light;
a drive signal generator configured to generate a first drive signal and a second drive signal respectively based on a first dropped signal corresponding to an optical signal dropped from the first wavelength division multiplexed optical signal and a second dropped signal corresponding to an optical signal dropped from the second wavelength division multiplexed optical signal and to generate a third drive signal and a fourth drive signal respectively based on a first add signal corresponding to an optical signal to be added to the first wavelength division multiplexed optical signal and a second add signal corresponding to an optical signal to be added to the second wavelength division multiplexed optical signal;
a first optical modulator configured to modulate the second oscillation light in accordance with the first drive signal to generate a first modulated optical signal;
a second optical modulator configured to modulate the third oscillation light in accordance with the second drive signal to generate a second modulated optical signal;
a third optical modulator configured to modulate the fourth oscillation light in accordance with the third drive signal to generate a third modulated optical signal;
a fourth optical modulator configured to modulate the fifth oscillation light in accordance with the fourth drive signal to generate a fourth modulated optical signal;
a polarization controller configured to control polarization states of the first oscillation light, the first through fourth modulated optical signals based on the polarization state estimated by the polarization estimator; and
a non-linear optical medium to which the first wavelength division multiplexed light, the first oscillation light whose polarization state is controlled by the polarization controller and the first through fourth modulated optical signals whose polarization states are controlled by the polarization controller are input, wherein
a difference in optical frequency between the first oscillation light and the second oscillation light is substantially equal to a difference in optical frequency between the reference light and an optical signal dropped from the first wavelength division multiplexed optical signal,
a difference in optical frequency between the first oscillation light and the third oscillation light is substantially equal to a difference in optical frequency between the reference light and an optical signal dropped from the second wavelength division multiplexed optical signal,
a difference in optical frequency between the first oscillation light and the fourth oscillation light is substantially equal to a difference in optical frequency between the reference light and an optical signal to be added to the first wavelength division multiplexed optical signal,
a difference in optical frequency between the first oscillation light and the fifth oscillation light is substantially equal to a difference in optical frequency between the reference light and an optical signal to be added to the second wavelength division multiplexed optical signal.

16. An optical add/drop multiplexer that processes wavelength division multiplexed light containing reference light and a polarization multiplexed optical signal in which a first wavelength division multiplexed optical signal transmitted in a first polarization and a second wavelength division multiplexed optical signal transmitted in a second polarization are multiplexed, the first polarization and the second polarization being orthogonal to each other, the optical add/drop multiplexer comprising:
an optical splitter configured to split the wavelength division multiplexed light to generate first wavelength division multiplexed light and second wavelength division multiplexed light;
a receiver configured to generate an electric signal from the second wavelength division multiplexed light by coherent detection;
a polarization estimator configured to estimate a polarization state of the wavelength division multiplexed light based on the electric signal;
an oscillator configured to generate an oscillation signal of a specified frequency;
a drive signal generator configured to generate a drive signal based on a dropped signal corresponding to an optical signal dropped from the first wavelength division multiplexed optical signal and the oscillation signal;
a light source configured to generate oscillation light of an optical frequency different from an optical frequency of the wavelength division multiplexed light;
an optical modulator configured to modulate the oscillation light in accordance with the drive signal to generate a modulated optical signal;
a polarization controller configured to control a polarization state of the modulated optical signal based on the polarization state estimated by the polarization estimator; and
a non-linear optical medium to which the first wavelength division multiplexed light and the modulated optical signal whose polarization state is controlled by the polarization controller are input.

17. An optical add/drop multiplexer that processes wavelength division multiplexed light containing reference light and a polarization multiplexed optical signal in which a first wavelength division multiplexed optical signal transmitted in a first polarization and a second wavelength division multiplexed optical signal transmitted in a second polarization are multiplexed, the first polarization and the second polarization being orthogonal to each other, the optical add/drop multiplexer comprising:
an optical splitter configured to split the wavelength division multiplexed light to generate first wavelength division multiplexed light and second wavelength division multiplexed light;
a receiver configured to generate an electric signal from the second wavelength division multiplexed light by coherent detection;
a polarization estimator configured to estimate a polarization state of the wavelength division multiplexed light based on the electric signal;
a light source configured to generate first oscillation light, second oscillation light and third oscillation light, optical frequencies of the second oscillation light and the third oscillation light being different from an optical frequency of the first oscillation light;
a drive signal generator configured to generate a first drive signal and a second drive signal respectively based on a first dropped signal corresponding to an optical signal dropped from the first wavelength division multiplexed optical signal and a second dropped signal corresponding to an optical signal dropped from the second wavelength division multiplexed optical signal;
a signal combiner configured to combine the first and second drive signals to generate a first combined signal and a second combined signal based on the polarization state estimated by the polarization estimator;
a first optical modulator configured to modulate the second oscillation light in accordance with the first combined signal to generate a first modulated optical signal;
a second optical modulator configured to modulate the third oscillation light in accordance with the second combined signal to generate a second modulated optical signal;
a first polarization controller configured to make a polarization state of the second modulated optical signal orthogonal to the first modulated optical signal;
a second polarization controller configured to control polarization states of the first oscillation light, the first modulated optical signal and the second modulated optical signal whose polarization state is controlled by the first polarization controller, based on the polarization state estimated by the polarization estimator; and
a non-linear optical medium to which the first wavelength division multiplexed light, the first oscillation light whose polarization state is controlled by the second polarization controller and the first and second modulated optical signals whose polarization states are controlled by the second polarization controller are input.

18. An optical signal processing method that processes wavelength division multiplexed light containing reference light and a polarization multiplexed optical signal in which a first wavelength division multiplexed optical signal transmitted in a first polarization and a second wavelength division multiplexed optical signal transmitted in a second polarization are multiplexed, the first polarization and the second polarization being orthogonal to each other, the method comprising:
splitting the wavelength division multiplexed light to generate first wavelength division multiplexed light and second wavelength division multiplexed light;
generating an electric signal from the second wavelength division multiplexed light by coherent detection;
estimating a polarization state of the wavelength division multiplexed light based on the electric signal;
generating first oscillation light and second oscillation light, an optical frequency of the second oscillation light being different from an optical frequency of the first oscillation light;
generating a drive signal based on at least one of a dropped signal corresponding to an optical signal dropped from the first wavelength division multiplexed optical signal and an add signal corresponding to an optical signal to be added to the first wavelength division multiplexed optical signal;
modulating the second oscillation light in accordance with the drive signal to generate a modulated optical signal;
controlling a polarization state of the first oscillation light and the modulated optical signal based on the estimated polarization state; and
inputting, to a non-linear optical medium, the first wavelength division multiplexed light, the first oscillation light whose polarization state is controlled and the modulated optical signal whose polarization state is controlled.
